(19) United States
(12) Patent Application Publication
(10) Pub. No.: US 2026/0030949 A1
(43) Pub. Date: Jan. 29, 2026

(54) REMOVABLE ASSEMBLY SYSTEM FOR GAMING MACHINE, GAMING MACHINE WITH REMOVABLE ASSEMBLY SYSTEM AND METHOD FOR ASSEMBLING GAMING MACHINE

(71) Applicant: AGS LLC, Las Vegas, NV (US)

(72) Inventors: Ryan Patrick Rye, Suwanee, GA (US); Ely Tillery, Tucker, GA (US); Matt Rodgers, Cumming, GA (US)

(73) Assignee: AGS LLC, Las Vegas, NV (US)

(21) Appl. No.: 18/786,946

(22) Filed: Jul. 29, 2024

(51) Int. Cl. G07F 17/32

(52) U.S. Cl. CPC G07F 17/3216

(57) ABSTRACT

A gaming machine cabinet for a gaming machine with a monitor assembly includes a base cabinet and a tower assembly. The tower assembly includes a chassis, a lower tower and an upper tower. A monitor assembly is mounted to the chassis. The upper tower is rotatably coupled to the lower tower and moveable between a shipping configuration and an installed configuration. A removable frame may be temporarily connected to the cabinet to form a ramp. A lift mechanism may be provided to lift the monitor assembly along the ramp during assembly of the gaming machine.

### FIELD OF THE INVENTION

The invention relates generally to gaming machines, and more particularly to a removable assembly system for a gaming machine, a gaming machine with a removable assembly, and a method for assembling a gaming machine.

### BACKGROUND OF THE INVENTION

Wager-based gaming machines have become increasingly complex. Originally, mechanical slot machines had metal cabinets which housed a plurality of spinning physical reels which displayed game symbols. The symbols were viewable through windows in a front of the gaming machine.

Gaming machines continue to evolve, both relative to their method of manufacture and their aesthetic appearance. For example, gaming machines are often modular now and may include a main unit with an upper unit. The main unit may include the components necessary for operation of the gaming machine, including, for example but not limited to, a controller and user input devices.

Mechanical reels may be replaced with video displays to simulate mechanical reels or to provide a video slot game. Further, other types of games may be provided on the video display or displays. One or more video displays may be provided on a single gaming machine. Generally, the size of such gaming machines and/or their associated video displays is increasing. This may present a problem which shipping and/or assembling such machines on a gaming floor.

For instance, the overall height of the gaming machine when assembled may exceed the size of standard shipping containers. Further, such displays (and/or an assembly including one or more displays) may be relatively heavy making the assembly process more difficult or requiring more than one person.

The present invention is aimed at one or more of the problems identified above.

### BRIEF SUMMARY OF THE INVENTION

In a first aspect of the present invention, a gaming machine cabinet for a gaming machine with a monitor assembly includes a base cabinet and a tower assembly. The tower assembly includes a chassis, a lower tower and an upper tower. A monitor assembly is mounted to the chassis. The upper tower is rotatably coupled to the lower tower and moveable between a shipping configuration and an installed configuration. A removable frame may be temporarily connected to the cabinet to form a ramp. A lift mechanism may be provided to lift the monitor assembly along the ramp during assembly of the gaming machine.

In a second aspect of the present invention, a gaming machine cabinet for a gaming machine with a monitor assembly including a base cabinet, a tower assembly, a removable frame, and a lift mechanism is provided. The base cabinet has an upper end, a bottom end, and a front side. The tower assembly includes a chassis configured to receive the monitor assembly. The tower assembly further includes a lower tower and an upper tower. The lower tower is coupled to the upper end of the base cabinet and extends upward therefrom. The upper tower is rotatably coupled at a pivot point to the lower tower and is movable between a shipping configuration and an installed configuration. The removable frame has a first end and a second end and has a storage state and an assembly state. At at least a portion of the removable frame is stored within the base cabinet or tower assembly when the removable frame is in the storage state. When in the assembly state, the first end of the removable frame is coupled to the tower assembly and the removable frame extends downward and away from the tower assembly and base cabinet toward the second end of the removable frame forming a ramp. The lift mechanism is coupled to the tower assembly and has an attachment device configured to be temporarily coupled to the monitor assembly. The lift mechanism is configured to controllably lift the monitor assembly along the ramp formed by the removable frame until the monitor assembly is in position relative to the tower assembly.

In a third aspect of the present invention, an assembly process for a gaming machine cabinet of a gaming machine with a monitor assembly is provided. The gaming machine cabinet has a base cabinet, a tower assembly, a removable frame and a lift mechanism. The base cabinet has an upper end, a bottom end, and a front side. The tower assembly has a chassis configured to receive the monitor assembly. The tower assembly includes a lower tower and an upper tower. The lower tower is coupled to the upper end of the base cabinet and extends upward therefrom. The upper tower is rotatably coupled to the lower tower and is movable between a shipping configuration and an installed configuration. The removable frame has a first end and a second end. The removable frame has a storage state and an assembly state. The removable frame is composed from a set of removable frame components stored within the gaming machine cabinet when in the storage state. The lift mechanism is coupled to the tower assembly and has an attachment device configured to be temporarily coupled to the monitor assembly and to controllably lift the monitor assembly along the ramp formed by the removable frame until the monitor assembly is in position relative to the tower assembly. The method includes the steps of removing the removable frame components from the gaming machine cabinet, assembling the removable frame components into the removable frame, temporarily connecting the removable frame to the gaming machine cabinet, and leaning the monitor assembly against the ramp formed by the removable frame. The method further includes the steps of attaching the attachment device of the lift mechanism to the monitor assembly, lift the monitor assembly using the lift mechanism such that the monitor assembly slides along, and is guided by, the ramp formed by the removable frame, and once the monitor assembly reaches a desired position, affixing the monitor assembly to the gaming machine cabinet.

In a fourth aspect of the present invention, a gaming machine cabinet for a gaming machine with a monitor assembly having a base cabinet, a tower assembly, a removable frame, a button deck, and a lift mechanism. The base cabinet has an upper end, a bottom end, and a front side. The tower assembly has a chassis configured to receive the monitor assembly. The tower assembly includes a lower tower and an upper tower. The lower tower is coupled to the upper end of the base cabinet and extends upward therefrom. The upper tower is rotatably coupled at a pivot point to the lower tower and is movable between a shipping configuration and an installed configuration. The lower tower has a lower tower upper end and a lower tower bottom end. The lower tower bottom end is coupled to the upper end of the base cabinet. The lower tower extends from the upper end of the base. The upper tower has an upper tower upper end and an upper tower bottom end and the upper tower bottom end being rotatably coupled to the lower tower upper end at the pivot point. The upper tower being movable about the pivot point between a shipping configuration and an installed configuration, wherein the upper tower extends upward from the lower tower when in the installed configuration. The removable frame has a first end and a second end and a storage state and an assembly state. At least a portion of the removable frame is stored within the base cabinet or tower assembly when the removable frame is in the storage state. In the assembly state, the first end of the removable frame is coupled to the tower assembly. The removable frame extends downward and away from the tower assembly and base cabinet toward the second end of the removable frame, forming a ramp. The button deck is coupled to the front side of base cabinet and extends therefrom. The lift mechanism is coupled to the tower assembly and has an attachment device configured to be temporarily coupled to the monitor assembly and to controllably lift the monitor assembly along the ramp formed by the removable frame until the monitor assembly is in position relative to the tower assembly. The ramp defined by the removable frame, is located adjacent the button deck, such that the monitor assembly avoids the button deck as the monitor assembly is lifted into position by the lift mechanism. The lift mechanism includes a winch having a winch cable. The attachment device includes a pair of carabiner clips coupled to one end of the winch cable.

In a fifth aspect of the present invention, a gaming machine cabinet having a base cabinet, a button panel, a tower assembly, and a lift mechanism is provided. The button panel is attached to a face of the base cabinet. The tower assembly includes a lower tower connected to the base cabinet and extending upward and an upper tower rotatably connected to the lower tower. The upper tower has a shipping configuration and an installed configuration. The chassis is rotatably connected to the upper tower. The removable frame includes a plurality of rail components. When the removable frame is in a storage state, the plurality of rail components are positioned between the chassis and a back wall of the lower tower. When the removable frame is in an assembly state, the plurality of rail components form a ramp extending from the chassis to the floor and having a central portion extending about the button panel. The central portion configured to avoid substantive contact with the button panel. The lift mechanism is coupled to the tower assembly and includes an attachment device configured to be temporarily coupled to a monitor assembly. The lift mechanism is configured to controllably move the monitor assembly along the removable frame to the chassis.

### BRIEF DESCRIPTION OF THE SEVERAL VIEWS OF THE DRAWINGS

These and other features and advantages of the present invention will become more readily appreciated when considered in connection with the following detailed description and appended drawings.

FIG. 1A is a perspective view of a gaming machine cabinet having a main unit, an upper unit, and a monitor assembly, according to an embodiment of the present invention.

FIG. 1B is a second perspective view of the gaming machine cabinet of FIG. 1A.

FIG. 2A is a perspective view of the gaming machine cabinet of FIG. 1A in a shipping configuration, according to an embodiment of the present invention.

FIG. 2B is a second perspective view of the gaming machine cabinet of FIG. 1A in the shipping configuration, according to an embodiment of the present invention.

FIG. 3A is a side view of the gaming machine cabinet of FIG. 1A, including a tower assembly including a lower tower and an upper tower, according to an embodiment of the present invention.

FIG. 3B is a first partial perspective view of the lower tower and the upper tower of FIG. 3A.

FIG. 4A is a second partial perspective view of the lower tower and the upper tower of FIG. 3A.

FIG. 4B is a third partial perspective view of the lower tower and the upper tower of FIG. 3A.

FIG. 5 is rear perspective view of the gaming machine cabinet of FIG. 1A in shipping configuration.

FIG. 6 is a partial perspective of the lower tower of FIG. 3A.

FIG. 7A is a partial perspective view of the lower tower of FIG. 3A, including a removable frame, according to an embodiment of the present invention.

FIG. 7B is a perspective view of a portion of the removable frame of FIG. 7A.

FIG. 7C is a perspective view of a portion of the removable frame of FIG. 7A including a button deck of the main unit of the gaming machine cabinet.

FIG. 8A is a side view of the gaming machine cabinet of FIG. 1A, a monitor assembly and a portion of a lift mechanism, according to an embodiment of the present invention.

FIG. 8B is a rear perspective partial view of the gaming machine cabinet and monitor assembly of FIG. 8A.

FIG. 8C is a partial rear perspective of the upper tower and monitor assembly.

FIG. 8D is a partial perspective view of a portion of the lift mechanism of FIG. 8A.

FIG. 8E is a second partial rear perspective of the upper tower and monitor assembly.

FIG. 9A is a partial perspective view of a portion of the lift mechanism of FIG. 8A.

FIG. 9B is a second partial perspective view of a portion of the lift mechanism of FIG. 8A.

FIG. 10A is a second partial rear perspective of the upper tower and monitor assembly.

FIG. 10B is a third partial rear perspective of the upper tower and monitor assembly.

FIG. 10C is a fourth partial rear perspective of the upper tower and monitor assembly.

FIG. 11A is a rear perspective view of a topper monitor, according to an embodiment of the present invention.

FIG. 11B is a rear perspective view of the topper monitor of FIG. 11A and a topper assembly.

FIG. 12A is a rear perspective view of the topper monitor of FIG. 11A, the topper assembly of FIG. 11B, and the monitor assembly of FIG. 1A.

FIG. 12B is a second rear perspective view of the topper monitor of FIG. 11A, the topper assembly of FIG. 11B, and the monitor assembly of FIG. 1A.

FIG. 12C is a second rear perspective view of the topper monitor of FIG. 11A, the topper assembly of FIG. 11B, and the monitor assembly of FIG. 1A.

FIG. 13A is a first perspective view of a gaming machine cabinet having a main unit, an upper unit, and a monitor assembly of FIG. 1A during assembly.

FIG. 13B is a rear perspective view of a portion of the gaming machine cabinet having a main unit, an upper unit, and a monitor assembly of FIG. 1A during assembly.

FIG. 13C is a front perspective view of a portion of the gaming machine cabinet having a main unit, an upper unit, and a monitor assembly of FIG. 1A during assembly.

FIG. 14A is a second rear perspective view of a portion of the gaming machine cabinet having a main unit, an upper unit, and a monitor assembly of FIG. 1A during assembly.

FIG. 14B is a second front perspective view of a portion of the gaming machine cabinet having a main unit, an upper unit, and a monitor assembly of FIG. 1A during assembly.

FIG. 14C is a third rear perspective view of a portion of the gaming machine cabinet having a main unit, an upper unit, and a monitor assembly of FIG. 1A during assembly.

FIG. 15A is a fourth rear perspective view of a portion of the gaming machine cabinet having a main unit, an upper unit, and a monitor assembly of FIG. 1A during assembly.

FIG. 15B is a fifth rear perspective view of a portion of the gaming machine cabinet having a main unit, an upper unit, and a monitor assembly of FIG. 1A during assembly.

FIG. 15C is a sixth rear perspective view of a portion of the gaming machine cabinet having a main unit, an upper unit, and a monitor assembly of FIG. 1A during assembly.

FIG. 15D is a rear view of a portion of the monitor assembly of FIG. 1A.

### DETAILED DESCRIPTION OF THE INVENTION

With reference to the figures, and in operation, the present invention provides a gaming machine 10 having a gaming machine cabinet 12. In the illustrated embodiment, the gaming machine 10 is a video gaming machine that may be utilized in providing one or more base games, such as video slot games, and/or bonus games to a player. However, it should be noted that the gaming machine 10 may be configured to provide other types of games. The gaming machine cabinet 12 generally includes a frame which may be comprised of different framing members (not shown) and/or may be at least partially comprised of other components of the gaming machine 10. In general, the term “frame” may refer to components of the gaming machine cabinet 12 to which other components are fastened, mounted, or otherwise connected thereto.

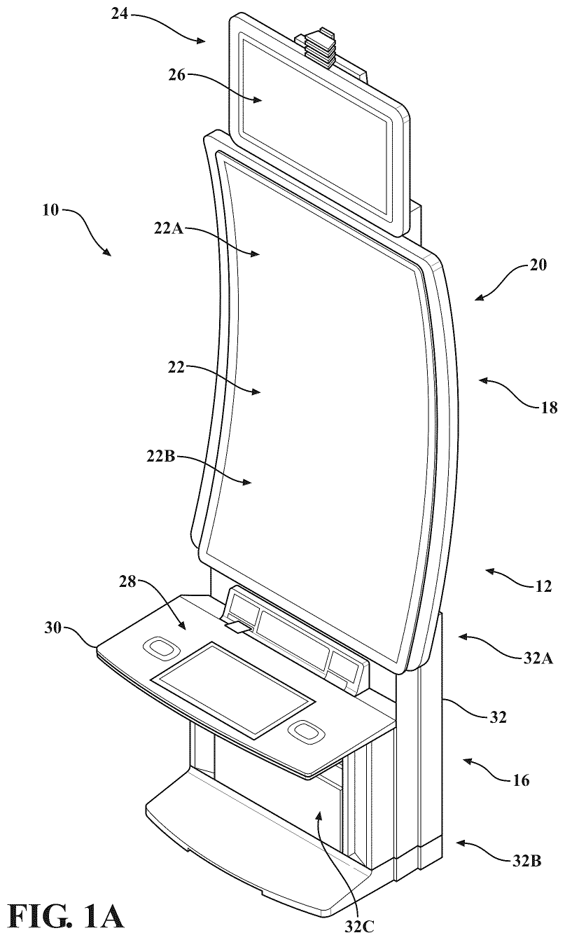

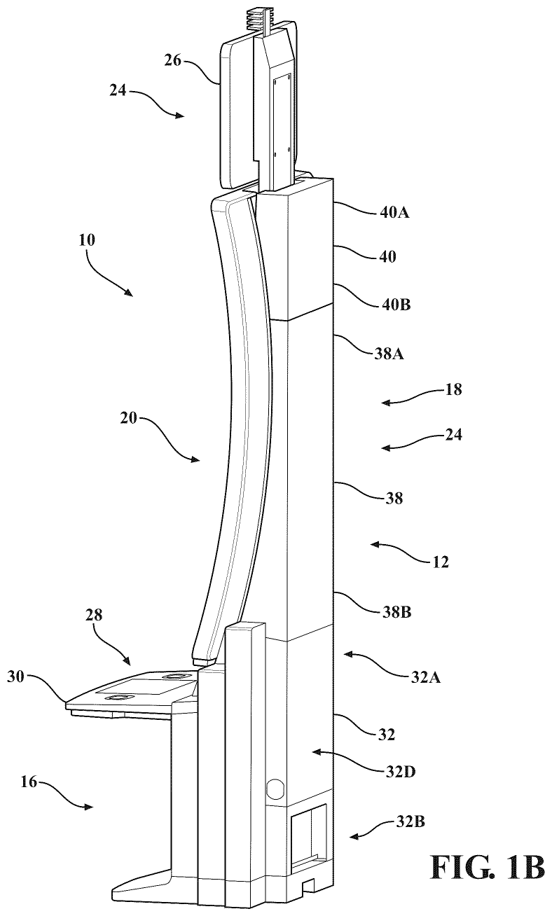

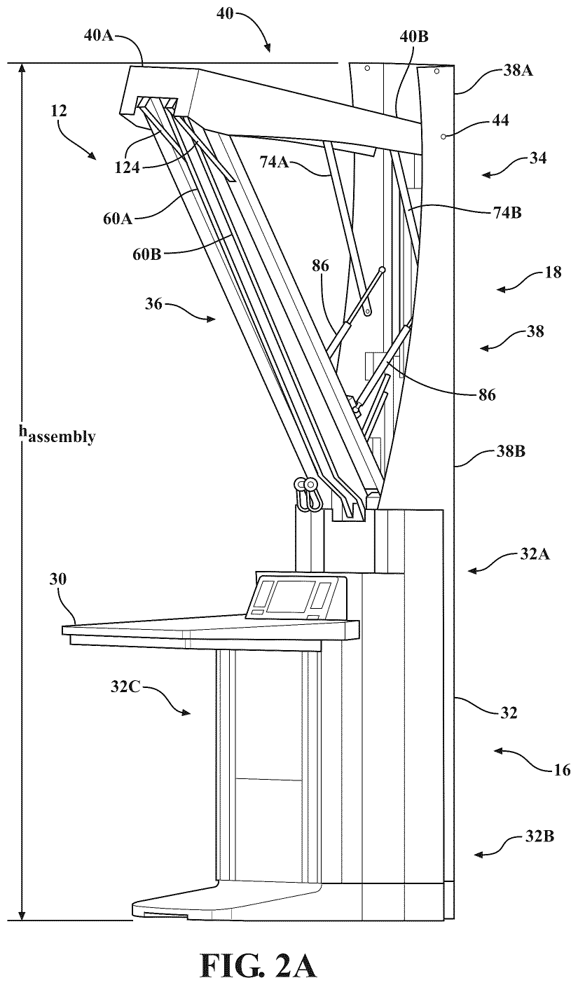

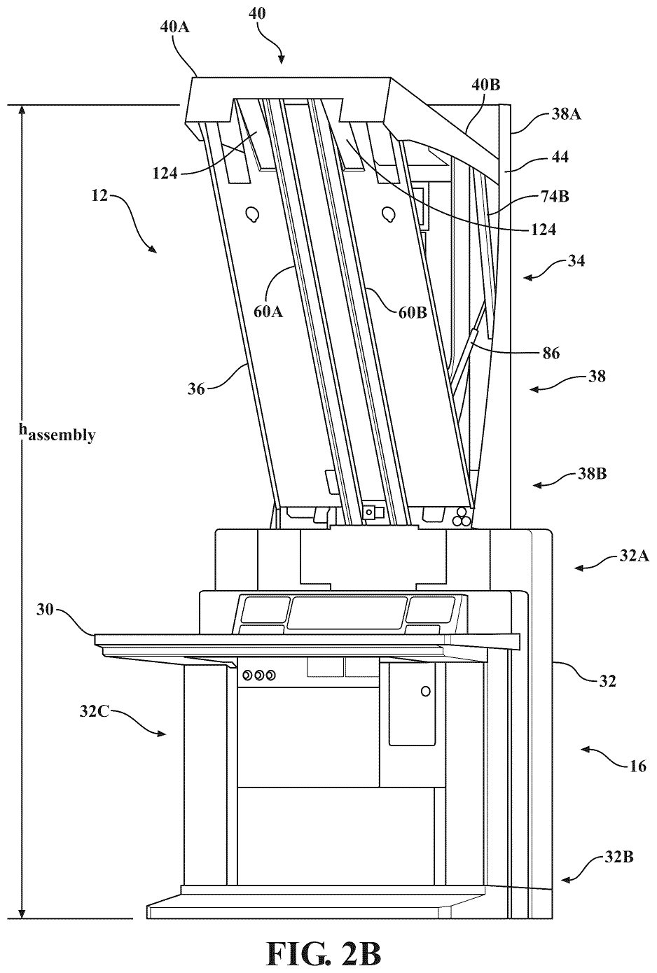

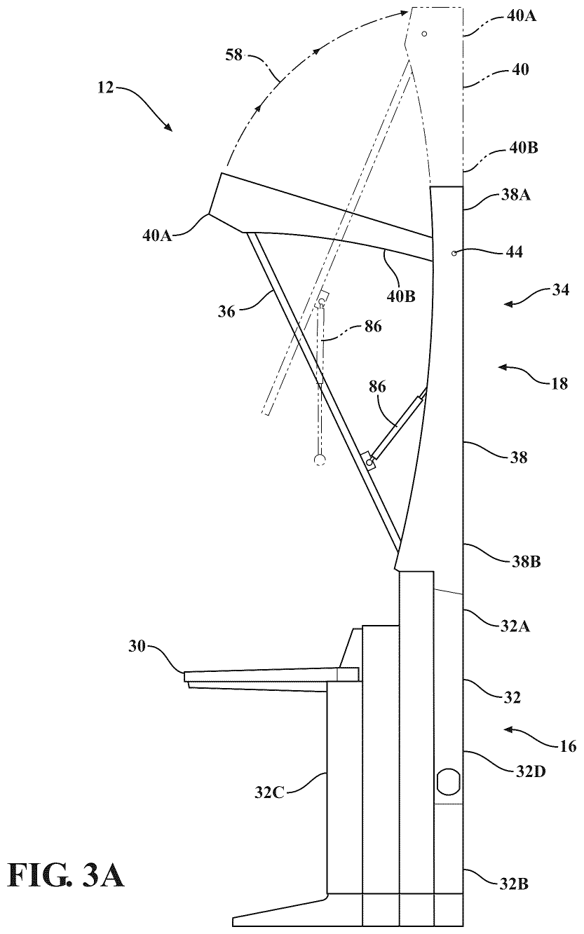

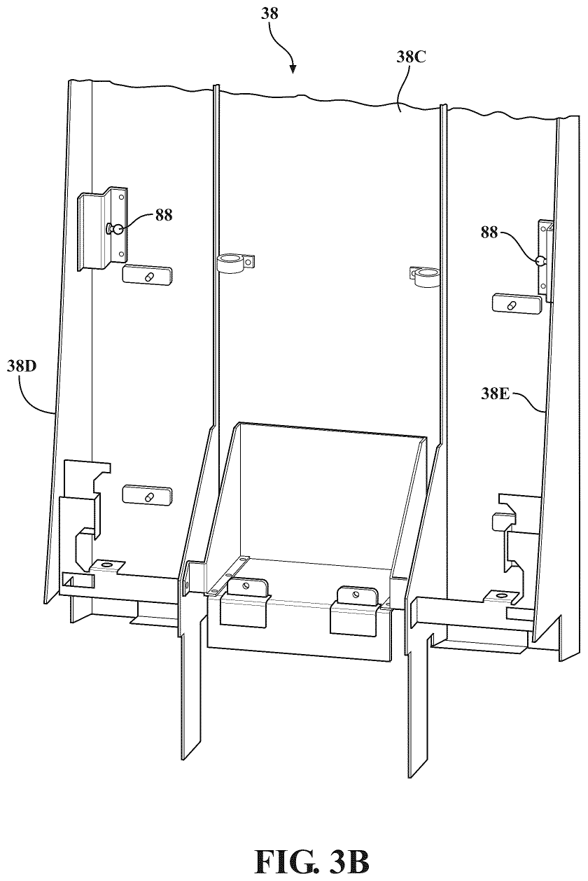

As discussed in more detail below, the gaming machine cabinet 12 is configurable or adjustable between an installed configuration (see for example, FIGS. 1A-1B) and an shipping configuration (see for example, FIGS. 2A and 3A).

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

The principles of the invention may be applied to gaming machines having various configurations. The gaming machine may be located at a casino (and as such may be referred to as a “casino gaming machine”). As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

### General Operation

One configuration of a gaming machine 10 to which aspects of the invention may be applied is illustrated in FIG. 1A. As illustrated, the gaming machine 10 generally includes the gaming machine cabinet (or housing) 12 for supporting and/or enclosing various components required for operation of the gaming machine. The gaming machine cabinet 12 may include one or more doors (not shown) or other access panels or features which can be moved between an open position which allows access to one or more interior portions of the gaming machine, and a closed position in which access to the one or more interior portions is generally prevented. The door(s) may include locks or other features for securing them in their closed positions. The configuration of the gaming machine 12 may vary, such as having other shapes or dimensions.

With reference to FIG. 1A, the illustrated gaming machine cabinet 12 includes a main or main unit 16 and an upper unit 18. Generally, in the illustrated embodiment, the main unit 16 houses various components of the gaming machine 10 in an internal cavity (not shown).

The upper unit 18 may house or include a monitor assembly 20 to display game information. The monitor assembly 20 may include one or more display devices 22. In the illustrated embodiment, the monitor assembly 20 includes a first display device 22A and a second display device 22B mounted adjacent in the monitor assembly 20. In another embodiment, the monitor assembly 20 may include a single display device 22. For example, in one embodiment the monitor assembly 20 may include a 75″ curved display. In another embodiment, monitor assembly 20 may include edge lighting components or systems (not shown).

Each display device 22, 22A, 22B may comprise an electronic video display as a high resolution flat panel liquid crystal display (LCD), projection LCD, plasma display, field emission display, digital micro-mirror display (DMD), digital light processing display (DLP), LCD touchscreen, a light emitting display (LED), and organic light emitting display (OLED), or other suitable displays now known or later developed, in a variety of resolutions, sizes and formats. The display devices 22, 22A, 22B may be capable of projecting or displaying a wide variety of information, including images, symbols and other indicia or information associated with game play, game promotion or other events.

The gaming machine 10 might also include a topper unit 24. The topper unit 24 may include a topper display 26 for displaying other game related information.

In general, the gaming machine 10 may be configured to present one or more games upon a player making a monetary payment or wager. In this regard, the gaming machine 10 may include a mechanism or means for accepting monetary value, such as a bill validator or a ticket reader, or may be configured to accept a wireless transfer of a monetary payment or wager. In one embodiment, certain game outcomes (but preferably not all game outcomes) may be designated as winning outcomes (the non-winning outcomes may be referred to as losing outcomes). Prizes or awards may be provided for winning outcomes, such as monetary payments (or representations thereof, such as prize of credits), or promotional awards as detailed herein. The gaming machine 10 may include a mechanism or means for returning unused monetary funds and/or dispensing winnings to a player.

With reference to FIGS. 1A and 1B, the gaming machine 10 preferably includes one or more player input devices 28 (such as input buttons, plunger mechanisms, a touch-screen display, joystick, touch-pad or the like). These one or more input devices 28 may be utilized by the player to facilitate game play, such as by providing input or instruction to the gaming machine 10. For example, such input devices 28 may be utilized by a player to place a wager, cause the gaming machine 10 to initiate a game, to “cash out” of the gaming machine, or to provide various other inputs. As illustrated, a button deck or panel 30 may extend outwardly from the front or face of the gaming machine cabinet 12 towards the player. In the illustrated embodiment, the button deck 30 is coupled to the front side 32C of the base cabinet 32 and extends therefrom. The button deck 30 may support, for example, the one or more of the input devices 28, such as buttons, a touch screen or the like.

In one embodiment, the gaming machine 10 includes at least one microprocessor or controller (not shown) for controlling the gaming machine 10, including receiving player input and sending output signals for controlling the various components or peripheral devices of the machine 10 (such as controlling game play and generating game information for display by the displays 22, 26). The controller may be arranged to receive information regarding funds provided by a player to the gaming machine 10, receive input such as a purchase/bet signal when a purchase/bet button is depressed, and receive other inputs from a player. The controller may be arranged to generate information regarding a game, such as generating game information for determining winning or losing game outcomes and controlling display of game play information and indicia on the displays 22, 26.

In general, the controller may be configured to execute machine readable code or “software” or otherwise process information, such as obtained from a remote server. Software or other instructions may be stored at a memory or data storage device, e.g., in a fixed or non-transitory configuration. The memory may also store other information or data, such as data stored in table(s) or other forms (including, but not limited to look-up tables, pay tables and other information, including tracked game play information). The gaming machine 10 may also include one or more random number generators for generating random numbers (such as implemented by a random number generator software module stored in the memory and executable by the processor or controller), such as for use in selecting game information and presenting the game in a random fashion (e.g. whereby the game is presented in a manner in which the player cannot control the outcome) or non-random fashion (e.g. such as where the game includes a skill component which can affect the outcome of the game).

The controller may be configured to execute machine readable code or instructions (e.g., software) which are configured to implement the game. In this regard, the gaming machine is specially configured to present the game via specific software and/or hardware which causes the gaming machine to operate uniquely. For example, the controller of the gaming machine 12 may be configured to detect a wager, such as a signal from a player's depressing of the “bet one” button (such as one of the buttons 28). Upon such an event and/or the player otherwise signaling the gaming machine to present the game, the controller may be configured to cause game related indicia and information, such as the outcome of a play of a game as a set of game symbols, to be displayed. The controller may accept input from a player of game inputs, such as a request to spin reels or the like, via the one or more player input devices of the gaming machine 10. As indicated above, the machine-readable code may be configured in various manners, such as by having various “modules” of software which are designed to implement specific features of the game play or game presentation.

The gaming machine 10 may be configured to generate and present games in a stand-alone manner or it may be in communication with one or more external devices at one or more times. For example, the gaming machine 10 may be configured as a server based device and obtain game code or game outcome information from a remote game server (in which event the gaming machine controller may receive game information from the server, such as game outcome information, and use that server-generated information to present the game at the gaming machine). For example, the gaming machine 10 might be configured as a stand-alone device or as a server-based device for presenting games as Class III games (as defined by the U.S. Indian Gaming Regulatory Act) or as a server-based device for presenting games as Class II games (as defined by the U.S. Indian Gaming Regulatory Act).

As indicated, the gaming machine 10 is configured to present one or more wagering games. The gaming machine 10 may be configured to accept value, such as in the form of coins, tokens, paper currency, physical indicia of value, or other elements or devices representing value such as monetary funds. Thus, as indicated above, the gaming machine 10 preferably includes a mechanism or means for accepting monetary value. For example, while not shown, the gaming machine 10 might include a coin acceptor for accepting coins. Of course, associated coin reading/verifying devices and coin storage devices may be associated with the gaming machine 10 if it is configured to accept coins. Likewise, the gaming machine 10 might include a currency accepting device having an acceptor slot or opening which is accessible through an access opening, such as in the front of the cabinet just above the button deck 30 As also described below, such a device may be configured to accept and read/verify paper currency and/or other media such as tickets (although the currency accepting device may be configured to accept and read not only currency, but tickets, media or elements other than currency, for ease of reference the device is referred to herein as a currency accepting device).

The gaming machine 10 might also be configured to read devices, such as magnetic stripe cards or other media having data associated therewith and via which value or funds may be associated with the gaming machine 10. The mechanism for accepting monetary value might also comprise hardware and/or software which allows a player to transfer (such as electronically) funds from an account, such as a casino wagering account, or a bank or other financial institution account. Such a mechanism might include a communication interface which permits the gaming machine to communicate with a mobile phone, PDA, tablet or other electronic device of the player (such as via a physical interface or wired or wireless communications links, such as to enable the transfer of funds from the player to the gaming machine or system).

When the player associates funds with the gaming machine 10 or an associated system, a credit balance is generated. The credit balance may comprise a plurality of monetary value credits. The player may wager some or all of the associated monetary value, such as by wagering one or more of the credits associated with the credit balance. For example, the player might provide input to a wager button or touch screen interface to wager a certain number of credits (such as “Bet 1 Credit”, “Bet 5 Credits”, “Bet Maximum Credits” or other options). In one embodiment, when the player's wager is received, the player's credit balance is reduced by the number of wagered credits. The player might then provide a separate input to begin the game. In other embodiment, the player might select a “play game” input, such as by pressing a “spin” button, which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In one embodiment, the gaming machine 10 may be configured to award winnings for one or more winning wagering game outcomes. Such winnings may be represented as credits, points or the like. In one embodiment, the player may “cash out” and thus remove previously associated funds and any awarded winnings or such may otherwise be paid to the player. These winnings may be associated with the player's credit balance, thus increasing the player's credit balance.

In one embodiment, the player may provide an input to the gaming machine 10 to indicate their desire to cash out, such as by selecting a “cash out” button (such as implemented via one of the buttons 30) or touch screen feature or providing other input. In response, a monetary value represented by the player's credit balance, or the like is preferably paid, transferred or otherwise provided to the player. For example, upon an award or at cash-out, associated funds may be paid to the player by the gaming machine 10 dispensing coins to a coin tray. In another embodiment, funds may be issued by dispensing paper currency or other media. In yet another embodiment, a player may be issued a media, such as a printed ticket, which ticket represents the value which was paid or cashed out of the machine. The aspects of gaming machine “ticketing” systems are well known. In yet another embodiment, the cash-out might result in the dispensing of a card or other media which stores or represents the cashed-out funds, such as by writing funds information to a magnetic stripe of a card which is inserted into a media writer of the gaming machine or dispensed from the machine. In other embodiments, the cash-out mechanism may result in the funds value being transferred to an external device or account, such as a player's casino account (such as associated with a casino server), a remote bank or other financial account, or an electronic device such as a player's phone, PDA, or tablet.

The gaming machine 10 may also include a player tracking device, such as a card reader and associated keypad. Such player tracking devices are well known and may permit the game operator to track play of players of the gaming machine. The tracked play may be utilized to offer player bonuses or awards.

A casino or gaming property may have numerous such gaming machines 10, such as located on a casino floor or in other locations. Of course, such gaming machines 10 might be used in other environments, such as an airport, a bar or tavern or other locations.

It will be appreciated that the gaming machine illustrated in FIG. 1A is only exemplary of one embodiment of a gaming machine. For example, it is possible for the gaming machine to have various other configurations, including different shapes and styles and having different components than as just described.

As noted, the gaming machine 10 may, as noted above, be part of a system which includes other devices. For example, the gaming machine 10 may communicate with one or more casino systems, such as a player tracking server or system, an accounting system or server, a ticketing system, a bonusing system, a tournament system, other gaming machines, and external devices.

### Tower Assembly and Removable Frame

With specific reference to FIGS. 1A and 1B, in the illustrated embodiment, the main unit 16 is comprised of, or includes, a base cabinet 32, and the upper unit 18 includes a tower assembly 34. The base cabinet 32 includes an upper end 32A, a bottom end 32B, a front side 32C, and a rear side 32D. As shown, the tower assembly 34 includes a chassis 36, a lower tower 38 and an upper tower 40.

The chassis 36 is configured to receive the monitor assembly 20. As will be discussed in more detail below, the lower tower 38 may be coupled to the upper end 32A of the base cabinet 32 and extend upward therefrom. The upper tower 40 may be rotatably coupled to the lower tower 38 at a pivot point 44 and moveable between a shipping configuration (shown in FIGS. 2 and 3A) and an installed configuration (sec FIGS. 1A-1B). In one embodiment, the pivot point 44 is fixed with respect to both the lower tower 38 and the upper tower 40.

In another embodiment, the pivot point 44 is fixed with respect to the lower tower 38. As will be discussed in more detail below, from the shipping configuration, the upper tower 40 is rotated upward about the pivot point 44. Once the upper tower 40 reaches vertical, the upper tower 40 drops or falls slightly relative to the lower tower 38 into position for the installed configuration.

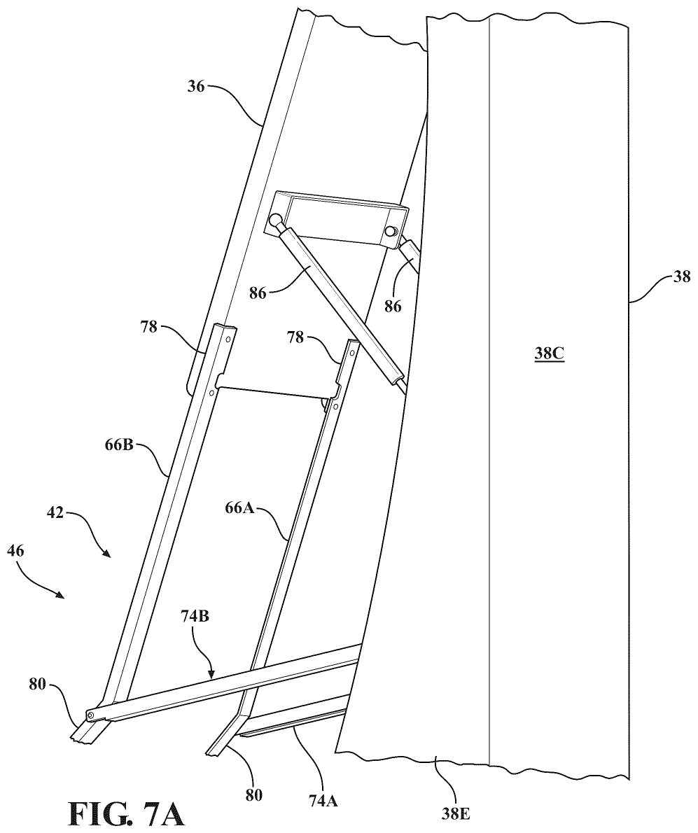

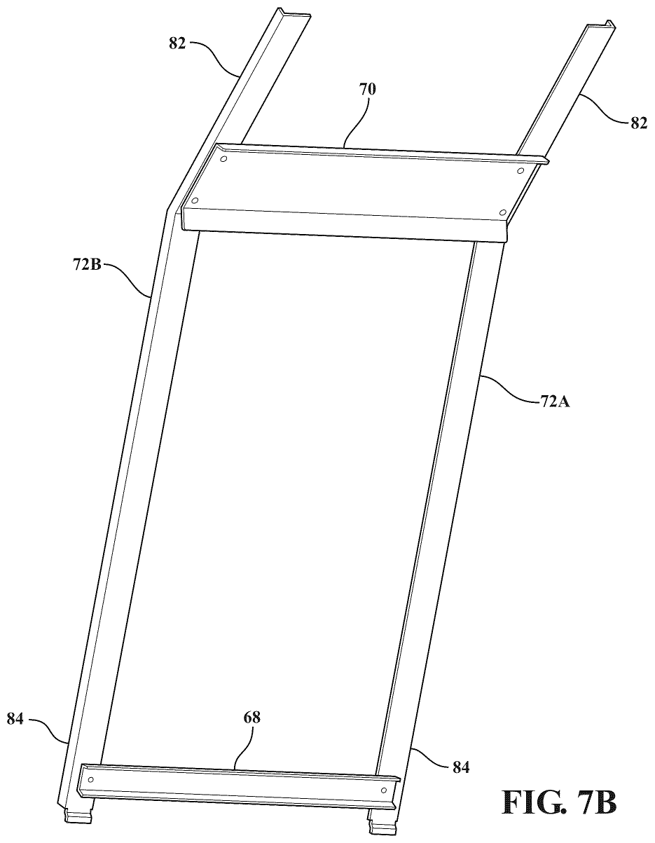

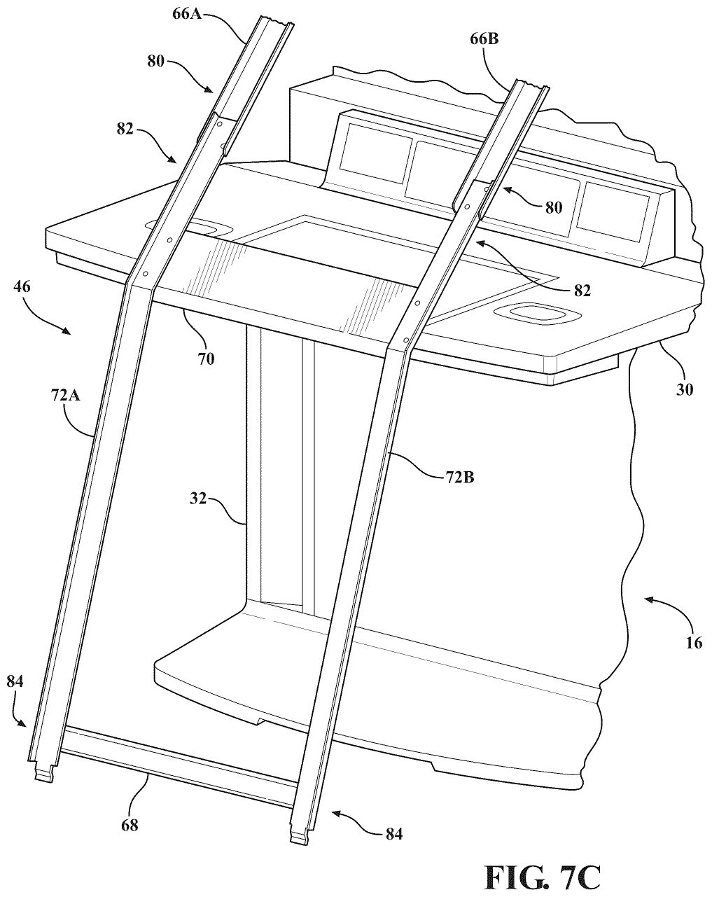

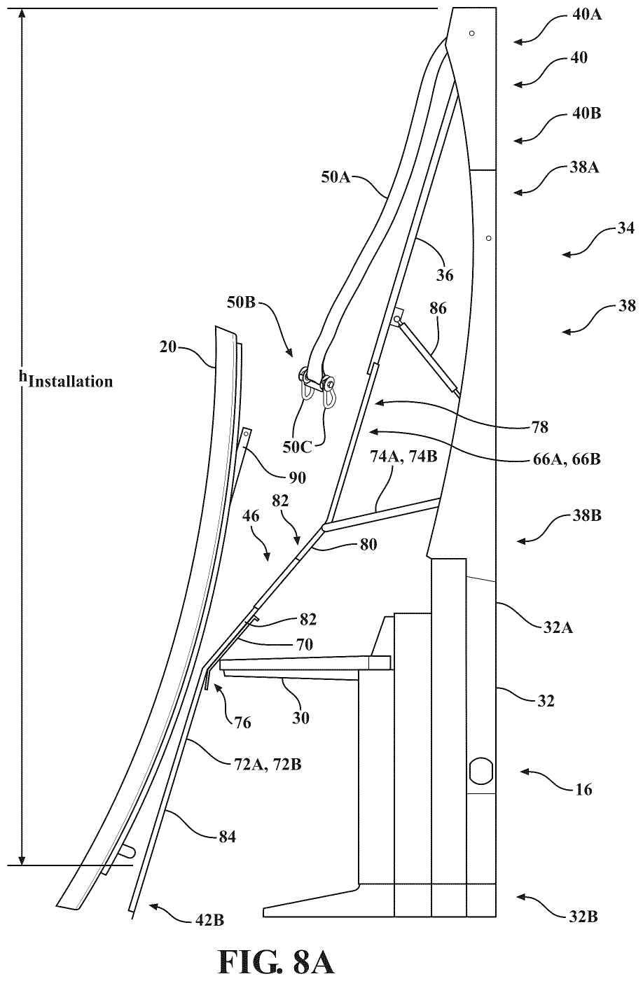

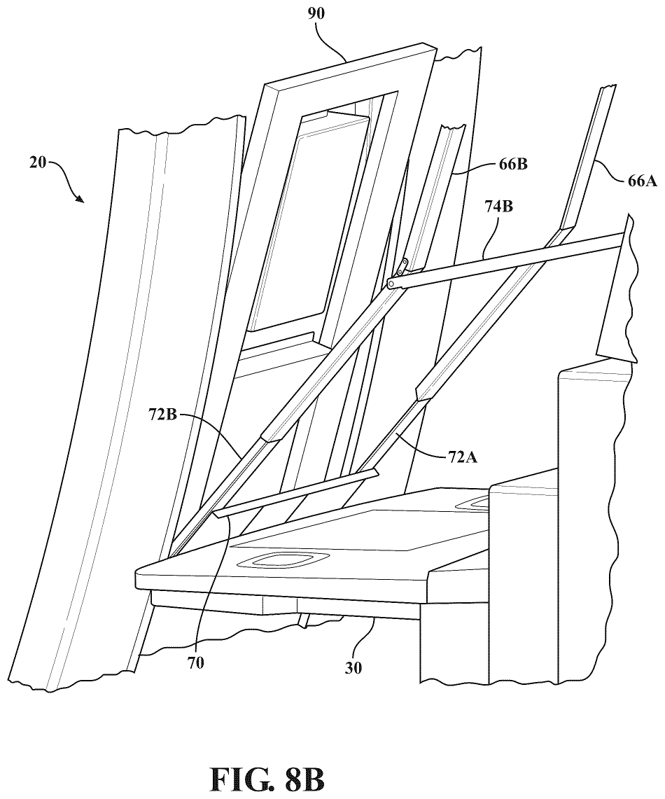

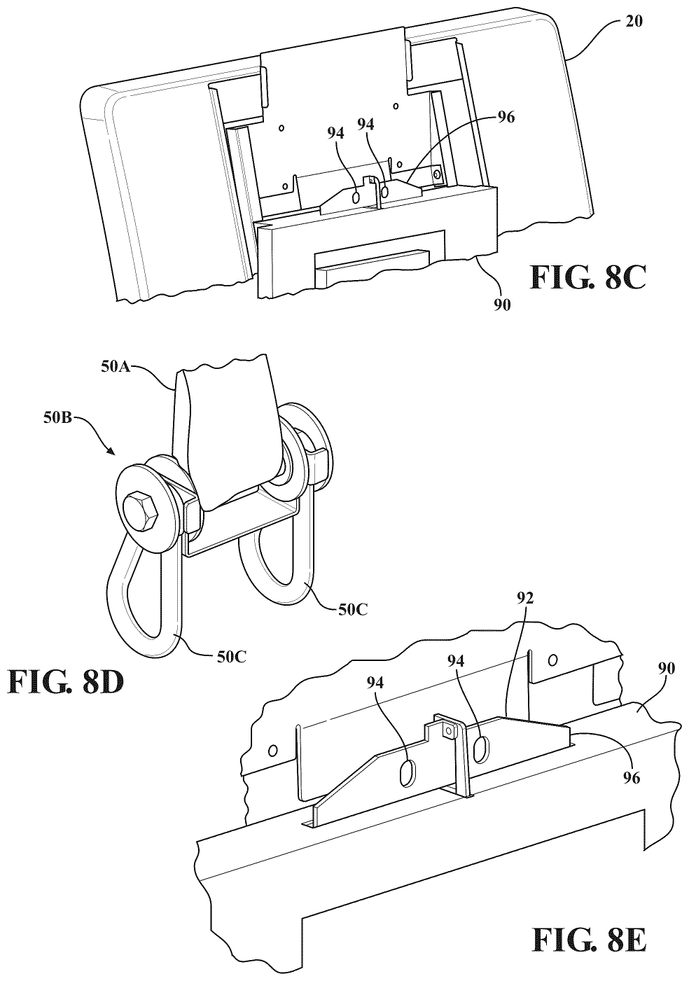

With reference to FIGS. 7A-7C and 8A-8B, in one aspect of the present invention, the gaming machine cabinet 12 may include a removable frame 42. In the illustrated embodiment, the removable frame 42 has a first end 42A and a second end 42B. The removable frame 42 has a storage state (see below), a dissembled state, and an assembly state (see FIGS. 7A-7C and 8A-8B). As discussed in more detail below, at least a portion of the removable frame 42 is stored within the base cabinet 32 or tower assembly 34 when the tower assembly 34 (or gaming machine cabinet 12) is in the storage state, for example, when the gaming machine cabinet 12 is being shipped or transported. Generally, the removable frame 42 may be in the disassembled state when being stored, i.e., in the storage state, or when removed from the gaming machine cabinet 12. As discussed in further detail below, to assemble the gaming machine cabinet 12, the components of the removable frame 42 may have to be removed from the base cabinet 32 or tower assembly 34 (the dissembled state), assembled and mounted to the gaming machine cabinet 12 (the assembly state).

With specific reference to FIG. 8A, when in the assembly state, the first end of 42A of the removable frame 42 may be coupled to the tower assembly 34. As shown, the removable frame 42 may extend downward and away from the tower assembly 42 and the base cabinet 32 toward the second end 42B of the removable frame 42. As shown, the removable frame 42 forms a ramp 46 which extends from the or near the floor to the tower assembly 34.

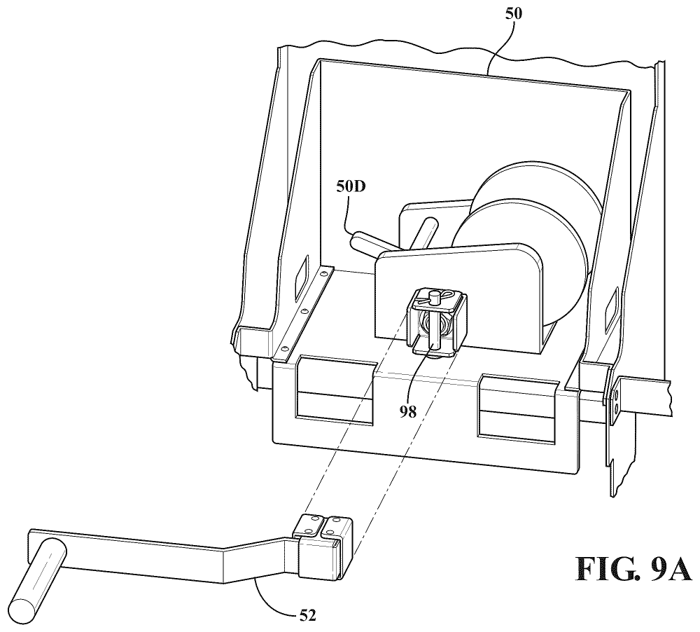

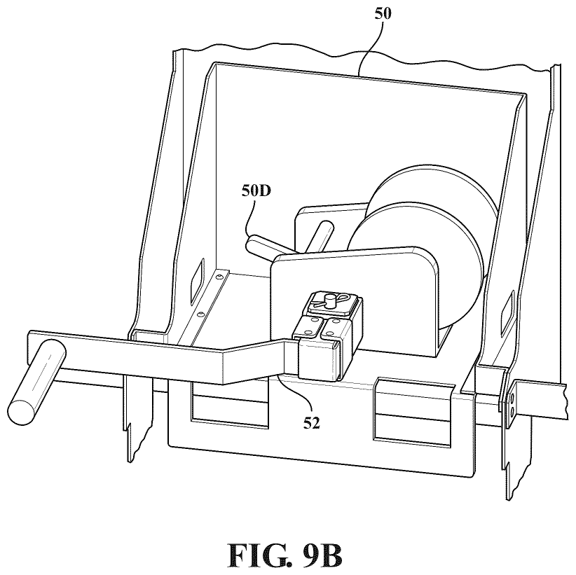

As shown in FIGS. 8A, 8D, and 9A-9B, the gaming machine cabinet 12 may include a lift mechanism 48 coupled or connected to the tower assembly 34. In the illustrated embodiment, the lift mechanism 48 includes an attachment device 50B, such as a pair of clips, configured to be temporarily coupled or connected to the monitor assembly 20. The lift mechanism 46 may be configured to controllably lift the monitor assembly 20 along the ramp 46 formed by the removable frame 42 until the monitor assembly 20 is in position relative to the tower assembly 34. Once the monitor assembly 20 is in position relative to the tower assembly 34, the monitor assembly 20 may be fastened or mounted to the chassis 36 (see below). In the illustrated embodiment, the lift mechanism 48 is a hand-crankable winch 50 with a removable handle 52 (see FIGS. 9A-9B), however it is contemplated that the lift mechanism 48 could be a mechanically-assisted winch (e.g., through use of a cordless drill, etc.), an electric winch, a hydraulic winch, a pulley system, or other lifting mechanism.

In the illustrated embodiment, the ramp 46 formed by the removable frame 42 is positioned adjacent, and extends over the button deck 30 such as to avoid the button deck 30. In other words, as shown, as the monitor assembly 20 is lifted into position, the ramp 46 is configured such that the monitor assembly 20 does not come into substantive contact with the button deck 30 or otherwise require the adjustment of the button deck 30 so as to avoid contact.

Once the monitor assembly 20 is mounted to the chassis 36, the removable frame 42 may be disconnected from the gaming machine cabinet 12, disassembled, and the individual components of the removable frame 42 mounted or stored back into the gaming machine cabinet 12. If the gaming machine 10, needs to be transported later, the process may be reversed such that the monitor assembly 20 may be removed or unmounted.

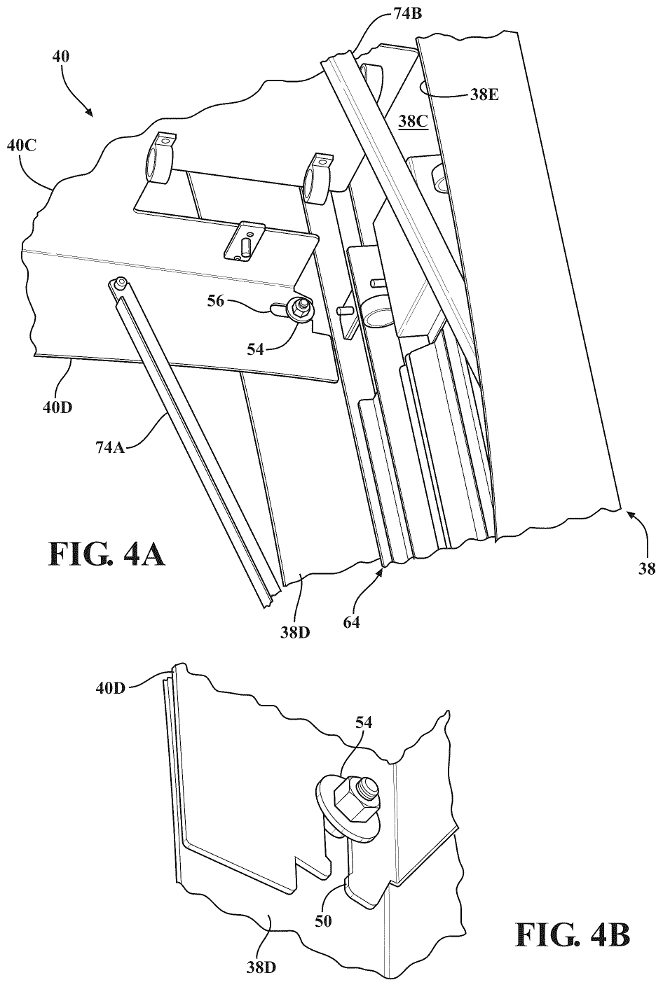

As shown, the lower tower 38 may be fixedly connected or mounted to the base cabinet 32. With particular reference to FIGS. 2A-2B, 3A and 5, in the illustrated embodiment, the lower tower 38 includes a rear panel 38C, and first and second side flanges 38D, 38E extending from the rear panel 38C to provide rigidity and strength to the lower tower 38. With particular reference to FIGS. 4A-4B, the pivot point 44 is located, and defined, in/by the first and second side flanges 38D, 38E. The upper tower 40 is rotatably coupled to the lower tower 38 at the pivot point 44, by a fastener 54 at each side of the tower assembly 34 (only one of which is shown), such as a nut and bolt and/or sleeve bearing.

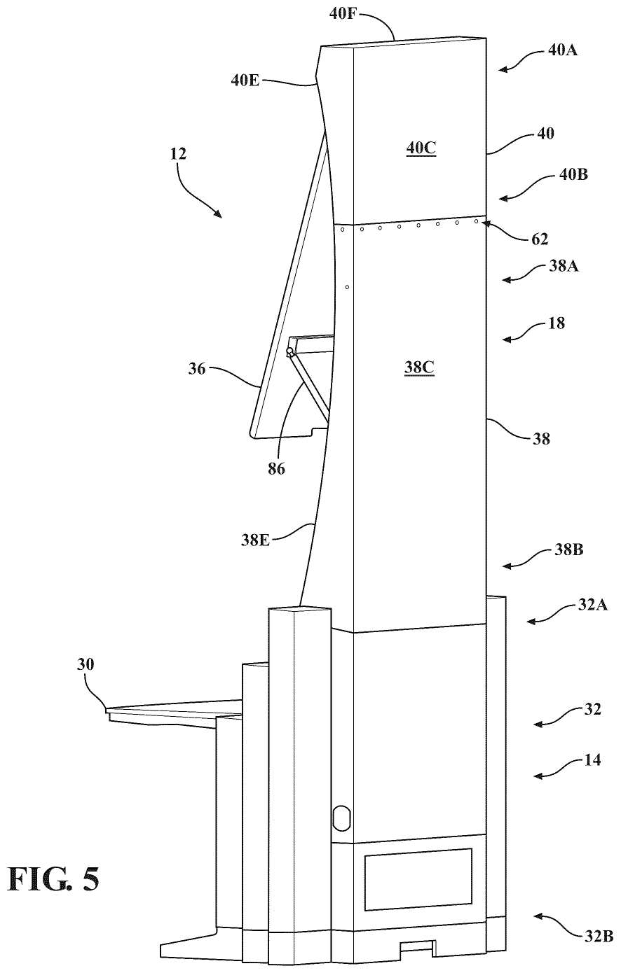

As shown, the upper tower 40 includes a rear panel 40C, first and second side flanges 40D, 40E and an upper flange 40F. The first, second and upper flanges 40D, 40E, 40F provide rigidity and strength to the upper tower 40. As shown in FIGS. 4A-4B, each side flange 40D, 40E of the upper tower 40 includes a slot 56. With particular reference to FIG. 3A, as discussed in more detail below during assembly, the upper tower 40 is lifted or rotated 58 from the shipping configuration (shown in solid lines) to the installation configuration (shown in phantom lines) along the path defined by dotted line 58. Once the upper tower 40 is vertical (shown in phantom), the upper tower 40 will fall slightly relative to the lower tower 38 (constrained by the slot 56 in each of the first and second flanges 40D, 40E of the upper tower 40 and the fasteners 54). The upper tower 40 may be secured to the lower tower 38 by a plurality of fasteners (not shown) inserted through the rear panel 38C of the lower tower 38 and into the rear panel 40C of the upper tower 40 at a plurality of fastening locations 62 (see FIG. 5).

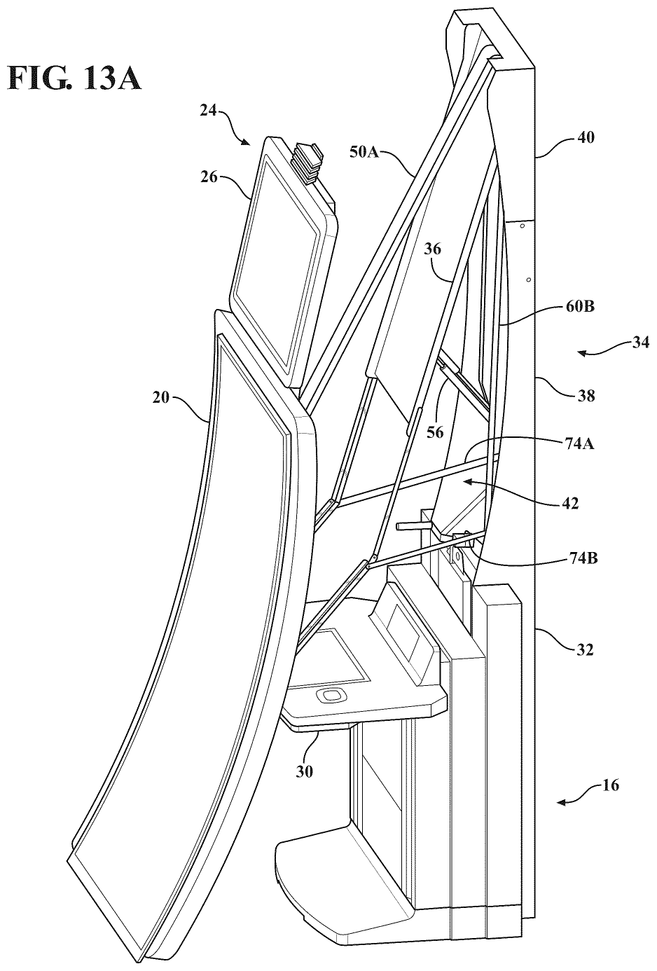

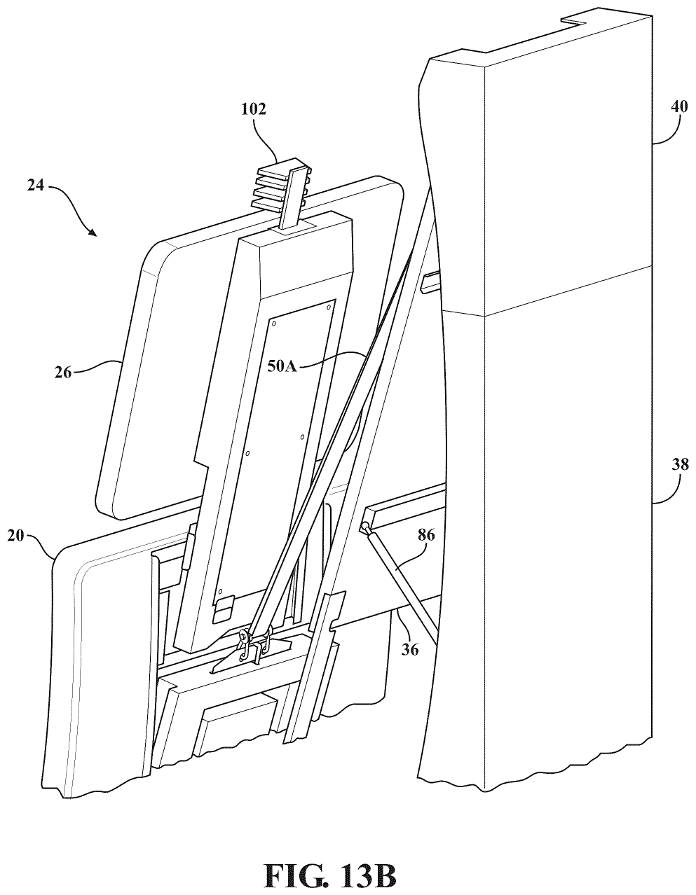

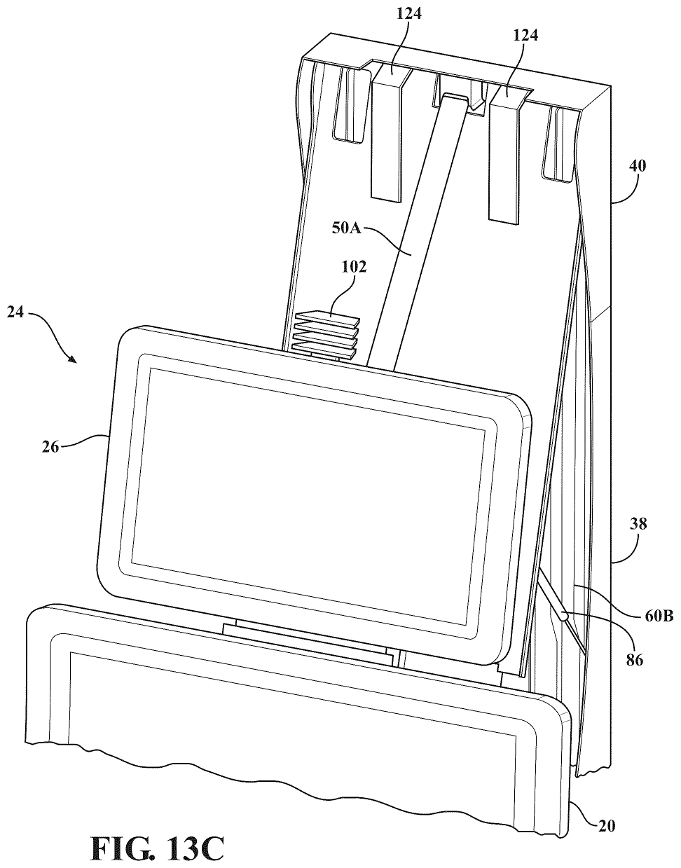

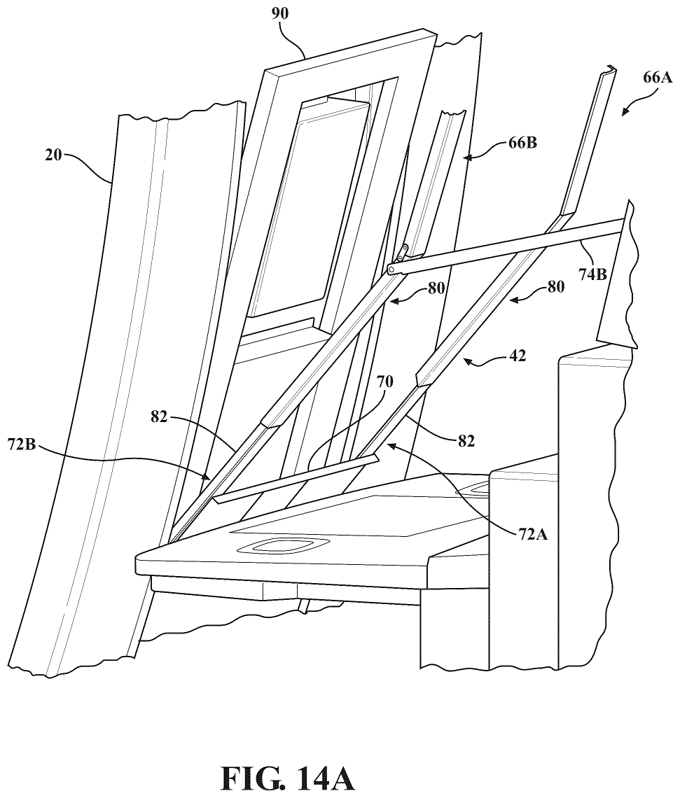

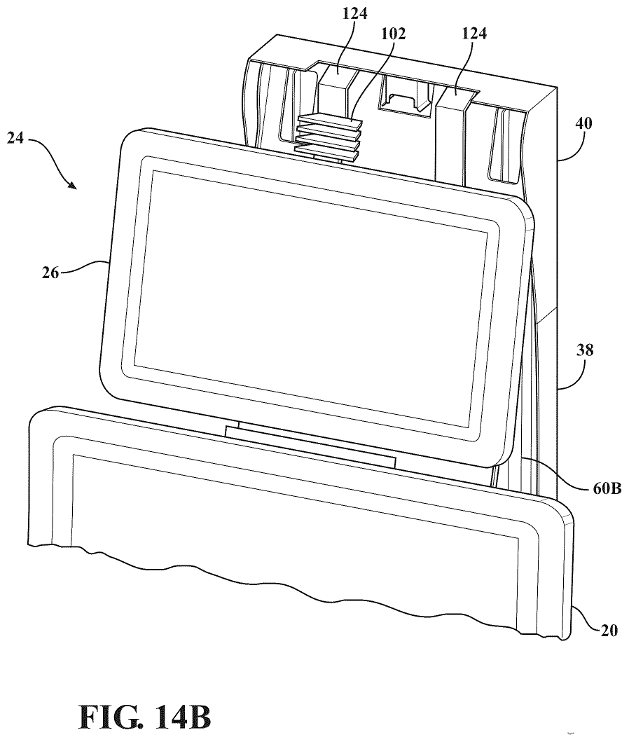

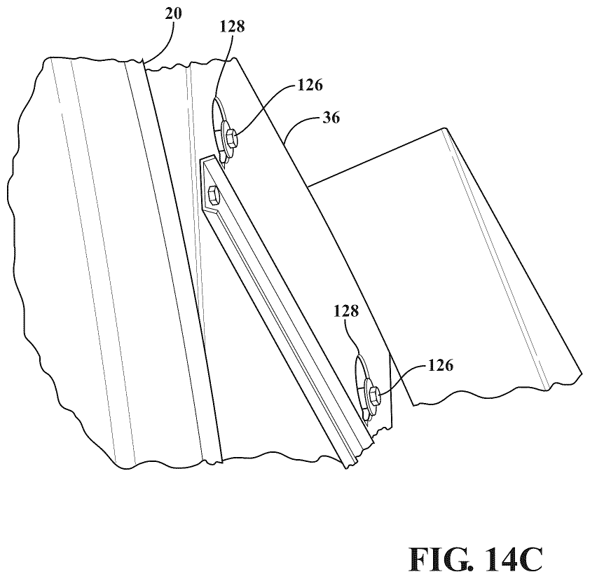

With reference to FIGS. 2A-2B, the tower assembly 34 may include a pair of supports 60A, 60B. In the illustrated embodiment, each support 60A, 60B is a vertical U-channel stiffeners. The supports 60A, 60B may temporarily affixed to a surface of the chassis 36 when the tower assembly 34 is in the shipping configuration. The supports 60A, 60B may be affixed to the chassis 36 by a set of fasteners (not shown), such as flat head screws, washers, and locknuts. Once the upper tower 40 is vertical, the supports 60A, 60B may be fastened along an interior surface of both of the rear panels 38C, 40C of the lower tower 38 and the upper tower 40 (see FIGS. 13A, 13C, 14B) to assist secure the upper tower 40 to the lower tower 38 by appropriate fasteners (not shown).

With particular reference to FIGS. 7A-7C and 8A, the removable frame 42 may be assembled from a number of components 64 that may be stored or fastened within the gaming machine cabinet 12 when the removable frame 42 is disassembled (storage state). In the illustrated embodiment, the components 64 of the removable frame 42 includes a first upper rail 66A, a second upper rail 66B, a lower cross brace 68, a button deck area cross brace 70, a first lower rail 72A, and a second lower rail 72B. However, it should be noted that the removable frame 42 may be comprised of different configurations of components (including the number of components and shape of the components).

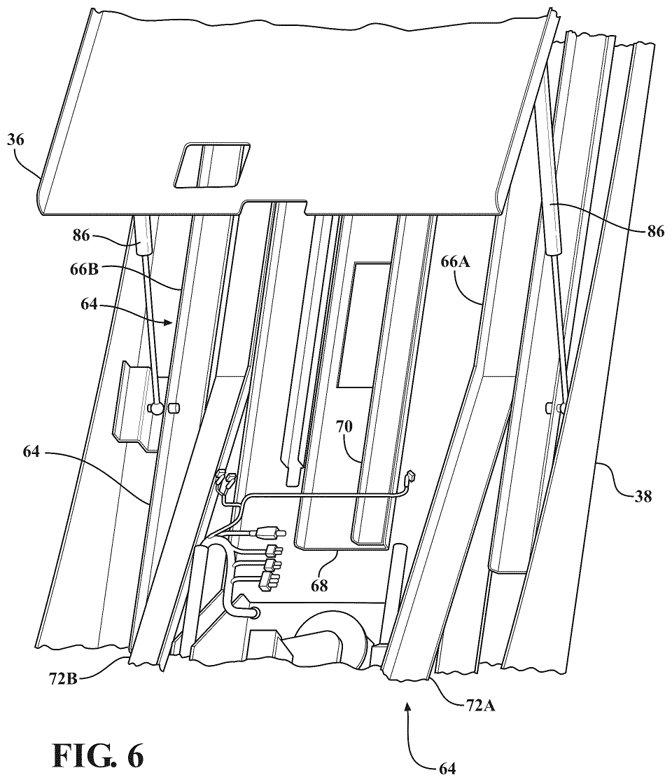

As shown in FIG. 6, the components 64 may be fastened to, and stored within, the tower assembly 34 when not in use by appropriate fasteners (not shown). During assembly, the components 64 are removed from the gaming cabinet 12 and assembled into an assembly state (FIGS. 8A and 7C). In one embodiment, the components 64 are composed from a metal, but may be composed from any suitable material and fastened together using appropriate fasteners (not shown).

As will be discussed in more detail below, the removable frame 42 when in the assembly state is used to assist in lifting the monitor assembly 20 using the lift mechanism 48 into position such that the monitor assembly 20 may be mounted to the chassis 36. While the monitor assembly 20 is being lifted into place, the monitor assembly 20 rests against, is support by, and slides along the removable frame 42. In the illustrated embodiment, the removable frame 42 includes a central portion 76 (see FIG. 8A) that juts out or extends outward relative the main unit 16 or base cabinet 32 as to enable the path of the monitor assembly 20 to avoid substantive the button deck 30. In this context, the term “substantive” means either (1) to avoid all contact between the removable frame 42 and the button deck or panel 30 and/or (2) only minimal contact such that there is no damage, including scratches or deformations, to the button deck or panel 30 or any components of the gaming cabinet 12 is attached or connected thereto. A number of rubber pads may be provided on a lower surface of the button deck area cross brace 70 and/or the rails 66A, 66B, 72A, 72B to protect the button deck 30 in case the removable frame 42 comes into contact with the button deck 30 under the weight of the monitor assembly 20 as the monitor assembly slides up the ramp 46 formed by the removable frame 42.

The central portion 76 of the removable frame 42 allows the button deck 30 to main connected to the base cabinet 32 during the shipping and assembly processes.

In the illustrated embodiment, a first end 78 of each of the upper rails 66A, 66B is attached to a bottom of the chassis 36 (see FIG. 7A). A second end 80 of each of the upper rails 66A, 66B has a slight L-bend. In one embodiment, the first and second ends 78, 80 of the upper rails 66A, 66B are composed of separate parts fastened together. In the illustrated embodiment, the upper rails 66A, 66B and the lower rails 72A, 72B overlap and fastened together using fasteners. A first end 82 of the lower rails 72A, 72B is fastened to the second end of a respective upper rail 66A, 66B. The first end 82 of the lower rails 72A, 72B also has a slight L-bend. When installed, a second end 84 of each of the lower rails 72A, 72B rests against the floor surface.

As shown in FIG. 7B, the button deck arca cross brace 70 may be fastened between the first and second lower rails 72A, 72B near the first ends 82 of the lower rails 72A, 72B. The lower cross brace 68 may be fastened between the first and second rails 72A, 72B near the second ends 84.

Returning to FIG. 8A, the removable frame 42 may be supported relative to the tower assembly 34 by a pair of frame supports 74A, 74B fastened to, and between, the second end 80 of the upper rails 66A, 66B and the lower tower 38 when the removable frame 42 is in the assembly state. As shown in FIG. 2A, the pair of frame supports 74A, 74B may be fastened to, and between, the lower and upper towers 38, 40 when the tower assembly 34 is in the shipping configuration.

Further, as shown in FIG. 8A, a pair of gas springs 86 fastened between the lower tower 38 and the chassis 36 support the chassis 36 and the monitor assembly 20 when the gaming machine 10 is fully assembled.

As shown, the second ends 80 of the upper rails 66A, 66B may have a U-shaped cross-section while the first ends 78 and a middle portion of the upper rails 66A, 66B may have a L-shaped cross-section. This helps ensure that the monitor assembly 20 is aligned and/or straight as the monitor assembly 20 is raised up the ramp 46 formed by the removable frame 42 and also helps prevent the higher-positioned monitor assembly 20 from being knocked off the upper rails 66A, 66B.

### Assembly

With reference to the drawings, and specifically to FIGS. 8A-8E, 9A-9B, 10A-10C, 11A-11B, 12A-12C, 13A-13C, 14A-14C. And 15A-15D, the present invention provides an assembly process for a gaming machine cabinet 12 for a gaming machine 10 that is moveable or changeable between a shipping configuration and an installed configuration. The gaming machine 10 may include a monitor assembly 20 and a topper unit 24 that are unmounted from the gaming machine cabinet 12 for shipping and installed or mounted to the gaming machine cabinet 12 at an installation location, for example, a casino floor. Generally, the gaming machine cabinet 12 when in the installed configuration (with or without the monitor assembly 20 and/or the topper unit 24 installed) has a height that would prevent the gaming machine 10 or gaming machine cabinet 12 from fitting within a standard shipping container (not). Thus, as explained above, and in further detail below, when the gaming machine cabinet 12 is in the shipping configuration, the height is shorter or less than the height in the installation configuration and fits within a standard shipping configuration.

The gaming machine cabinet 12 without the monitor assembly 20 and the topped unit 24 installed and in the shipping configuration is shown in FIGS. 2A and 2B. As shown, the upper tower 40 is pivoted or rotated forward about the pivot point 44 relative to the lower tower 38. Thus, the overall height of the gaming machine cabinet 12, h_{assembly}, in the installed configuration is defined by the bottom of the base cabinet 32 and an upper edge of the lower tower 38. As discussed above, the upper tower 40 is supported by the first and second frame supports 74A, 74B, which are temporarily connected between the lower tower 38 and the upper tower 40 as shown. As shown in FIG. 8A, once the gaming machine cabinet 12 has been fully assembly, the overall height of the gaming machine cabinet 12 is designated hᵢₙₛₜₐₗₗₐₜᵢₒₙ.

Once the gaming machine cabinet 12 has been delivered to an installation location, an assembly process is performed to assemble or place the gaming machine cabinet 12 into the installation configuration. Ideally, the assembly process may be performed by a single person or installer.

In a first step of the assembly process, the two supports 60A, 60B are detached from the underside of the chassis 36. The supports 60A, 60B may be fastened to the chassis 36 by a set of locknuts (not shown). The supports 60A, 60B are used to provide support to the tower assembly 34 when the upper tower 40 is in the upright position. The locknuts may be needed later if the gaming machine cabinet 12 needs to be stored or shipped/transported elsewhere while in the shipping configuration.

In a next step of the assembly process, the supports 74A, 74B are removed. The supports 74A, 74B may be used to support the removable frame 42 during later steps of the assembly process. In the illustrated embodiment, once the supports 74A, 74B are removed, the upper tower 40 is free to rotate, but is limited in it's downward rotation by the lower edge such the chassis 36 may hang freely suspended above the button deck 30 and not come into contact, touch or scratch the button deck 30. Cardboard or foam (not shown) may be used to protect the lower tower 40 or button deck 30 from the upper tower 38.

In a next step of the assembly process, as shown in FIG. 3A, the bottom of the chassis 36 is held by the installer and pushed upward to rotate the upper tower 40 in the direction of arrow 58. The chassis 36, thereby rotating the upper tower 40 until the upper tower 40 is vertical. Once the upper tower 40 is vertical, the slot 56 in the first and side flanges 40D, 40E of the upper tower 40 slide downward on the fasteners 54 resulting in the upper tower 40 dropping downward slightly, for example, about ¼″. Once the upper tower 40 drops, motion of the upper tower 40 is restricted so the installer may release the upper tower 40.

In one aspect of the present invention, the gas springs 86 may be connected to the back surface of the chassis 36 at one end, while the other end hangs freely. After the upper tower 40 is in place, the other end of each gas spring 86 may be snapped unto a respective mating ball stud 88 mounted to the rear panel 38C of the lower tower 38 (see FIG. 3B).

In a subsequent step of the assembly process, fasteners, e.g., flat head screws are inserted and fastened into the fastening locations, i.e., apertures or threaded screw holes, 62 into and through the lower tower 38 and into the upper tower 40, thereby affixing the upper and lower towers 38, 40 to each other (FIG. 5).

In a next step of the assembly process, the supports 60A, 60B which may be U-channel stiffeners are attached to the inner surface of the tower assembly 34 using suitable fasteners, for example, lock nuts. The supports 60A, 60B, span across at least a portion of the lower tower 38 and the upper tower 40 and are fastened thereto to provide support and rigidity to the tower assembly 34.

After the supports 60A, 60B are installed, the removable frame 42 must be assembled. As discussed above, during shipping all components 64 of the removable frame 42 are stored within and temporarily mounted within the gaming machine cabinet 12. As discussed above, the removable frame 42 includes first and second upper rails 66A, 66B, a lower cross brace 70, a button deck area cross brace 70, and first and second lower rails 72A, 72B. Further, the supports 60A, 60B may be used to support the removable frame 42 against the lower tower 38 during the rest of the assembly process.

In a next step of the assembly process, the removable frame components 54 are removed from the back wall of the tower assembly 34. In one embodiment the removable frame components 64 are composed from sheet metal and stored with the tower assembly 34 during shipping. The removable frame components 64 may be mounted to the tower assembly 34 using a set of wing nuts. In the illustrated embodiment, the removable frame components 64 are stacked together in storage positions (see FIGS. 6). After the gaming machine 10 has been assembled, the removable frame 42 may be disassembled and mounted again (including the first and second frame supports 74A, 74B) within the tower assembly 34 using the wingnuts.

After the removable frame components 54 have been removed from the tower assembly 34, the removable frame 42 is assembled.

In a subsequent step of the assembly process, the first ends 78 (FIGS. 7A and 8A) of the first and second upper rails 66A, 66B are fastened to respective bottom corners of the chassis 36 using appropriate fasteners such as wing nuts.

In a next step of the assembly process, the frame supports 74A, 74B are connected to both the gaming machine cabinet 12, for example, the lower tower 38 and the second end 80 of the first and second upper rails 66A, 66B (FIG. 7A).

In a next step of the assembly process, the first and second lower rails 72A, 72B are connected or fastened to the lower cross brace 68 and the button deck area cross brace 70 (collectively, a sub-assembly).

In a subsequent step of the assembly process, the sub-assembly 72A, 72B, 68, 70 is secured or fastened to the first and second upper rails 66A, 66B using wing nuts. After the eleventh step, the removable ramp 42 is assembled and mounted (temporarily) to the gaming machine cabinet 12.

Now, the monitor assembly 20 may be lifted into positioned and mounted to the chassis 36. As the monitor assembly 20 is being lifted, the monitor assembly 20 rests against, slides along and is guided by the ramp 46 formed by the removable frame 42.

In a next step of the assembly process, the monitor assembly 20 may be leaned against the removable frame 42 (see FIG. 8A). As shown in FIG. 8B, the monitor assembly 20 may include a sled 90 with a pair of latch brackets 92. When the monitor assembly 20 against the removable frame 42, the sled 90 and latch brackets 92 should by within the rails 66A, 66B, 72A, 72B.

As stated above, in the illustrated embodiment, the lift mechanism 48 is a hand operated winch 50 with a handle 52. The winch 50 includes a cable 50A attached to the winch 50 at one end and an attachment device 50B connected to the opposite end. In the illustrated embodiment the attached device is a pair of carabiner clips 50C.

In a next step of the assembly process, the installer grabs the winch cable 50A and hooks or connects the carabiner clips 50C to respective openings 94 in a bracket 96 mounted at the top of the sled 90 (FIGS. 8C, 8E).

When the gaming machine cabinet 12 is being shipped, the handle 52 of the winch 50 may be disconnected from the winch 50 and mounted within the gaming machine cabinet 12. In a fourteenth step of the assembly process, the handle 52 may be removed from the storage location and affixed to the winch 50 using a cotter pin. The winch 50 may include a winch pawl 50D which must be set to a position allowing the winch cable 50A to be loosened to allow the installed to create a desired amount of slack in the winch cable 50A.

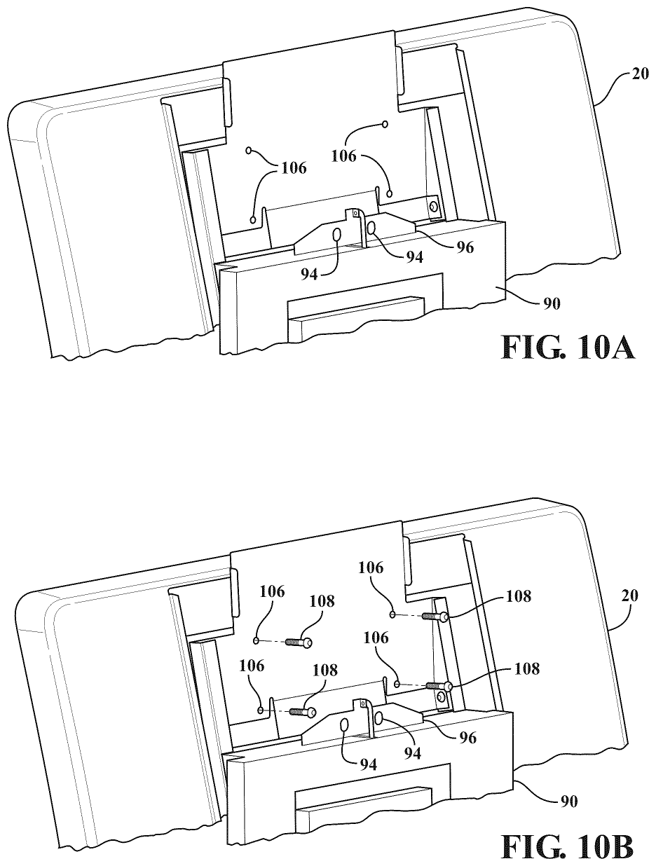

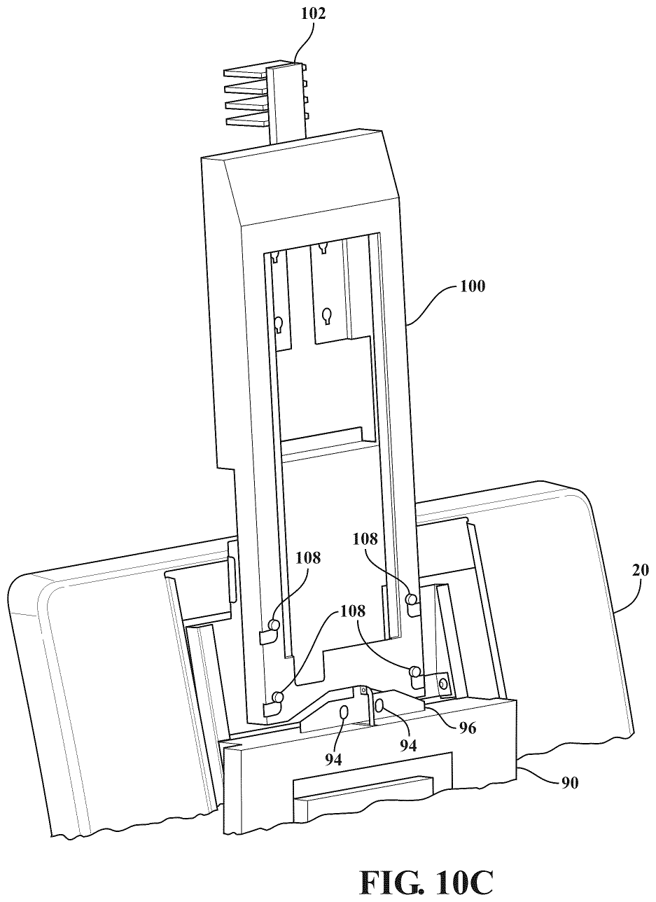

Prior to the monitor assembly 20 being lifted into place, if the gaming machine 10 is provided with a topper unit 24, the topper unit 24 may be installed or mounted to the monitor assembly 20. With reference to FIGS. 10A-10C, 11A-11B and 12A-12B, the topper unit 24 may include a topper neck 100 and an attendant light assembly 102.

With specific reference to FIGS. 10A-10B, the monitor assembly 20 includes a plurality of self-clenching nut locations 104 locate on a back surface thereof. In a fifteenth step of the assembly process, a set of bolts 106 are partially inserted into the self-clenching nut locations 104. In a subsequent step of the assembly process, the topper neck 100 may be lowered downward and then moved forward (arrows 110) such that bolts 106 pass through a set of key-hole shaped openings 108 on the topper neck 100. The bolts 106 may then be tightened to secure the topper neck 100 to the monitor assembly 20.

In a next step of the assembly process, a wire harness for the attendant light assembly 102 is plugged into the bottom of the attendant light assembly 102 and the attendant light assembly 102 is fastened to the top of the topper neck 100 using fasteners or screws (not shown) (see FIG. 10C).

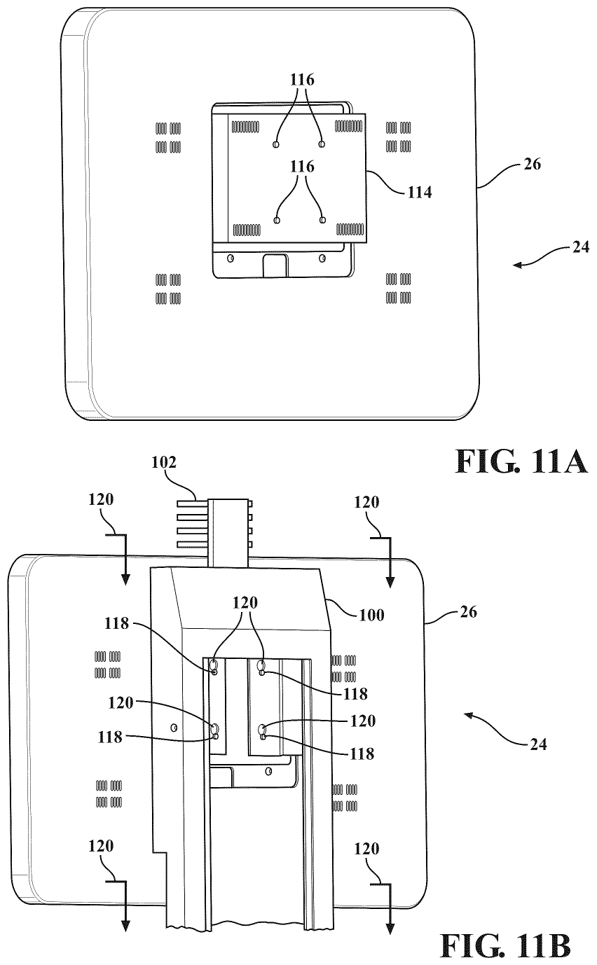

With reference to FIGS. 11A-11B, the topper display 26 may have a standard VESA mount 114 with a plurality of mounts 116. In an eighteenth step of the assembly process, a set of screws or fasteners 118 are inserted into the mounts 116.

With reference to FIGS. 11B, in a next step of the assembly process, the topper unit 24 may be mounted to the topper neck 100 by moving the topper unit 24 rearward and down (arrows 120) such that the heads of the screws 118 rest within the key-hole shaped openings 118.

In a subsequent step of the assembly process, all electrical harness connections to the topper unit 24 and/or topper display 26 may be made (generally at/through the rear of the topper unit 24. The opposite ends of the electrical harness may be routed through the topper neck 100 and left to temporarily hang freely.

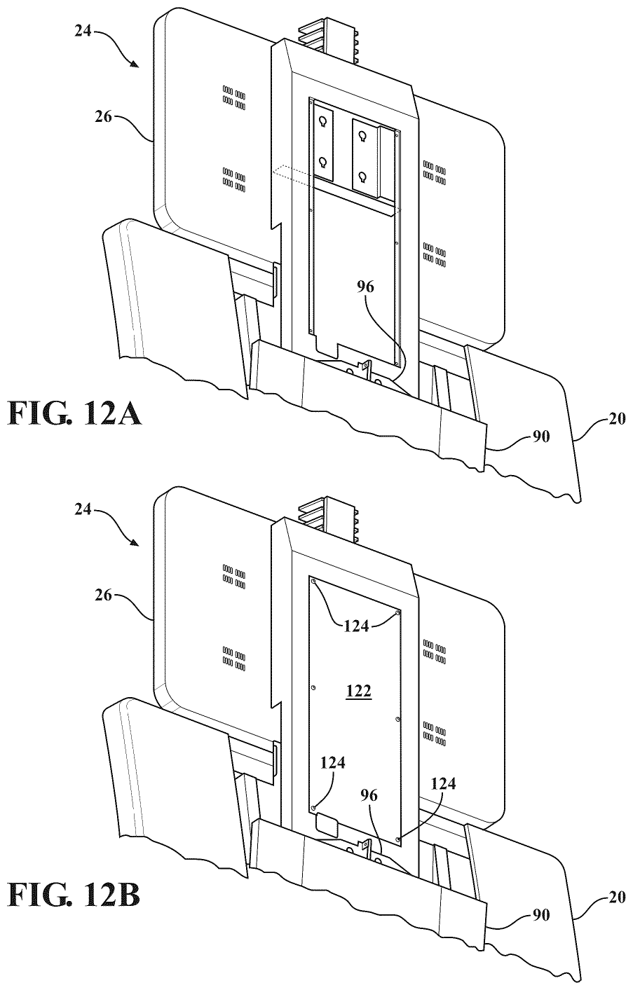

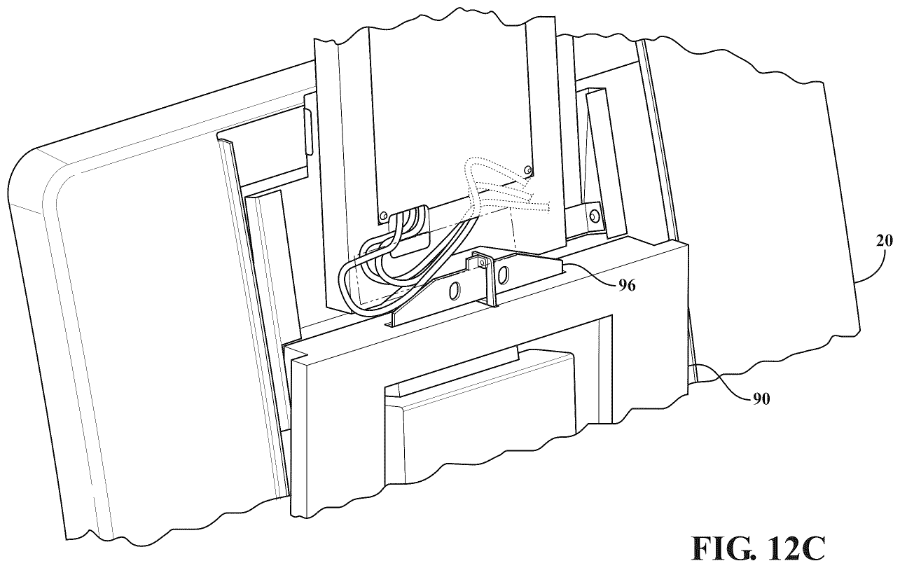

In a next step of the assembly process, a plate 122 may be attached to the rear of the topper neck 100 (FIG. 12B) using a plurality of screws 124.

In a next step of the assembly process, the ends of the cables or wire harness from the topper unit 24 are inserted into the topper neck 100. This prevents all topper cables/harnesses from being pinched or torn while the monitor assembly 20 is raised into position.

Once the topper unit 24 has been installed or mounted to the monitor assembly 24, the monitor assembly 24 may be raised. In a subsequent step of the assembly process, with the carabiner clips 50C still clipped to the openings 94 in the bracket 96 the handle 52 of the winch 50 is hand turned (in a clockwise direction) to raise the monitor assembly 20 upward and along the ramp 46 formed by the removable frame 42. In the illustrated embodiment, the rear of the topper neck 100 may rest or be in contact with the winch cable or strap 50A and may also be momentarily on contact with a pair of guide ramps 14 located at the top of the chassis 36.

As the monitor assembly 20 is raised upward, the installer should visually check that the sheet metal sled 90 on the rear of the monitor assembly 20 is sliding both “on” and “within/between” the left and right guide rails 66A, 66B, 72A, 72B of the removable frame 42 (see FIG. 14A).

Further, as the monitor assembly 20 slides up the ramp 46 formed by the removable frame 42, the rear surface of the topper unit 24 and the topper neck 100 will slide up and over the two guide ramps 124 (see FIG. 14B) in order that the attendant light assembly 102 avoids coming into contact with any wall or pole (not shown) directly behind the tower assembly 34.

With reference to FIG. 14C, as the monitor assembly 20 is lifted to the approximate correct height, two screw head 126 on the back of the monitor assembly 20 will fall into two keyhole openings 128 in the chassis 36 that the monitor slides on. At this point the monitor cannot fall/slide back down the chassis 36 since the entire weight of the monitor assembly 20 is supported by screw heads 126 and the keyhole openings 126.

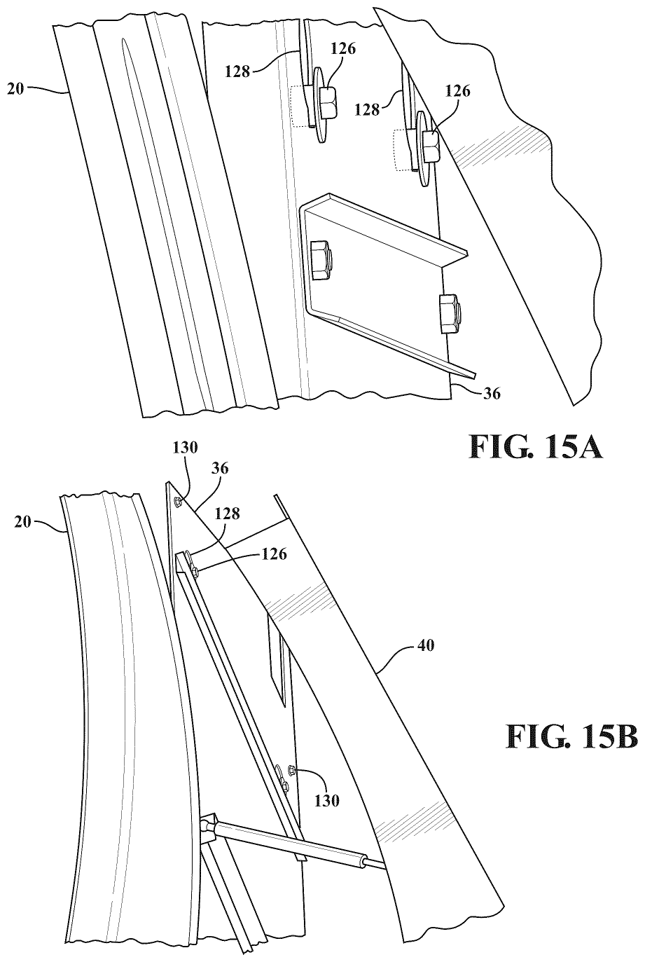

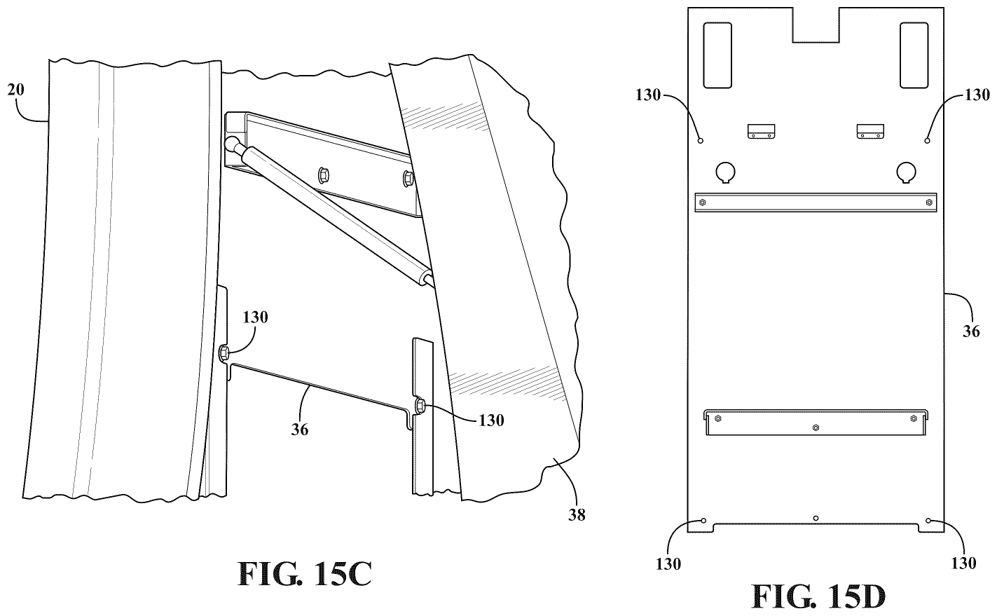

In a next step of the assembly process, the monitor assembly 20 may be secured to the chassis 36 by a set of screws 130 (FIGS. 15B-15D).

Once the monitor assembly 20 is secured to the chassis 36, the removable frame 42 may be removed from the gaming machine cabinet 12 and disassembled. Then, the components of the removable frame 64 may be mounted within the tower assembly 34 for storage (see above). All remaining electrical harness connections may be made and the monitor assembly 20 may be closed and latched shut. The steps of the assembly process have been presented or described above in a particular potential or possible order. However, it should be noted that to the extent possible, the steps could be performed in a different order.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A gaming machine cabinet for a gaming machine with a monitor assembly, comprising:
a base cabinet having an upper end, a bottom end, and a front side;
a tower assembly having a chassis configured to receive the monitor assembly, the tower assembly including a lower tower and an upper tower, the lower tower being coupled to the upper end of the base cabinet and extending upward therefrom, the upper tower being rotatably coupled to the lower tower and being movable between a shipping configuration and an installed configuration;
a removable frame having a first end and a second end, the removable frame having a storage state and an assembly state, wherein at least a portion of the removable frame is stored within the base cabinet or tower assembly when the removable frame is in the storage state, when in the assembly state, the first end of the removable frame being coupled to the tower assembly, the removable frame extending downward and away from the tower assembly and base cabinet toward the second end of the removable frame, and the removable frame forming a ramp; and,
a lift mechanism coupled to the tower assembly and having an attachment device configured to be temporarily coupled to the monitor assembly and to controllably lift the monitor assembly along the ramp formed by the removable frame until the monitor assembly is in position relative to the tower assembly.

2. The gaming machine cabinet, as set forth in claim 1, the lower tower having a lower tower upper end and a lower tower bottom end, the lower tower bottom end being coupled to the upper end of the base cabinet, the lower tower extending from the upper end of the base, the upper tower having upper tower upper end and an upper tower bottom end, the upper tower bottom end being rotatably coupled to the lower tower upper end at a pivot point, the upper tower being movable being movable about the pivot point between a shipping configuration and an installed configuration, wherein the upper tower extends upward from the lower tower when in the installed configuration.

3. The gaming machine cabinet, as set forth in claim 2, wherein the pivot point is defined by a fastener located at each side of the tower assembly.

4. The gaming machine cabinet, as set forth in claim 3, the upper tower including a slot at each side configured to receive a respective one of the fasteners, wherein, from the shipping configuration, the upper tower is rotated upward about the pivot point, when the upper tower reaches vertical, the slots and fasteners therein allow the upper tower to fall relative the lower tower.

5. The gaming machine cabinet, as set forth in claim 1, further including a button deck coupled to the front side of base cabinet and extending therefrom.

6. The gaming machine cabinet, as set forth in claim 2, wherein the ramp defined by the removable frame, is located adjacent the button deck, such that the monitor assembly avoids the button deck as the monitor assembly is lifted into position by the lift mechanism.

7. The gaming machine cabinet, as set forth in claim 1, wherein the lift mechanism includes a winch having a winch cable, the attachment device including a pair of carabiner clips coupled to one end of the winch cable.

8. The gaming machine cabinet, as set forth in claim 7, wherein is the winch includes a handle and is configured to be manually operated to raise the monitor assembly.

9. The gaming machine cabinet, as set forth in claim 1, wherein the removable frame is composed from a set of removable frame components which may be stored within the gaming machine cabinet when not in use.

10. The gaming machine cabinet, as set forth in claim 9, wherein the removable frame components includes first and second upper rails, first and second lower rails, and at least one cross brace.

11. The gaming machine cabinet, as set forth in claim 10, wherein the gaming machine cabinet includes a button deck and the at least one cross brace is a button deck area cross brace configured to protect the button deck as the monitor assembly is raised.

12. The gaming machine cabinet, as set forth in claim 1, further comprising a pair of supports, the pair of supports configured to be fastened to, and across, the upper and lower towers to provide support and rigidity to the tower assembly when in the installed configuration.

13. An assembly process for a gaming machine cabinet of a gaming machine with a monitor assembly, the gaming machine cabinet having a base cabinet, a tower assembly, a removable frame and a lift mechanism, the base cabinet having an upper end, a bottom end, and a front side, the tower assembly having a chassis configured to receive the monitor assembly, the tower assembly including a lower tower and an upper tower, the lower tower being coupled to the upper end of the base cabinet and extending upward therefrom, the upper tower being rotatably coupled to the lower tower and being movable between a shipping configuration and an installed configuration, the removable frame having a first end and a second end, the removable frame having a storage state and an assembly state, the removable frame composed from a set of removable frame components stored within the gaming machine cabinet when in the storage state, the lift mechanism coupled to the tower assembly and having an attachment device configured to be temporarily coupled to the monitor assembly and to controllably lift the monitor assembly along the ramp formed by the removable frame until the monitor assembly is in position relative to the tower assembly, comprising the steps of:
removing the removable frame components from the gaming machine cabinet;
assembling the removable frame components into the removable frame;
temporarily connecting the removable frame to the gaming machine cabinet;
leaning the monitor assembly against the ramp formed by the removable frame;
attaching attachment device of the lift mechanism to the monitor assembly;
using the lift mechanism, lift the monitor assembly such that the monitor assembly slides along, and is guided by, the ramp formed by the removable frame; and,
once the monitor assembly reaches a desired position, affixing the monitor assembly to the gaming machine cabinet.

14. The assembly process, as set forth in claim 13, the lower tower having a lower tower upper end and a lower tower bottom end, the lower tower bottom end being coupled to the upper end of the base cabinet, the lower tower extending from the upper end of the base, the upper tower having upper tower upper end and an upper tower bottom end, the upper tower bottom end being rotatably coupled to the lower tower upper end at a pivot point, the upper tower being movable being movable about the pivot point between a shipping configuration and an installed configuration, wherein the upper tower extends upward from the lower tower when in the installed configuration, the assembly process including the step of rotating the upper tower relative to the lower tower from the shipping configuration to the installation configuration.

15. The assembly process, as set forth in claim 13, wherein the gaming machine cabinet further includes a button deck coupled to the front side of base cabinet and extending therefrom.

16. The assembly process, as set forth in claim 15, wherein the ramp defined by the removable frame, is located adjacent the button deck, such that the monitor assembly avoids the button deck as the monitor assembly is lifted into position by the lift mechanism.

17. The assembly process, as set forth in claim 13, wherein the lift mechanism includes a winch having a winch cable, the attachment device including a pair of carabiner clips coupled to one end of the winch cable, further including the step of temporarily attaching the carabiner clips to a bracket located on the monitor assembly.

18. The assembly process, as set forth in claim 17, wherein is the winch includes a handle and is configured to be manually operated to raise the monitor assembly.

19. The assembly process, as set forth in claim 13, wherein the removable frame is composed from a set of removable frame components which may be stored within the gaming machine cabinet when not in use, the assembly process including the steps of dissembling the removable frame and storing the removable frame components back into the gaming machine cabinet after the monitor assembly is mounted.

20. The assembly process, as set forth in claim 19, wherein the removable frame components includes first and second upper rails, first and second lower rails, and at least one cross brace.

21. The assembly process, as set forth in claim 20, wherein the gaming machine cabinet includes a button deck and the at least one cross brace is a button deck area cross brace configured to protect the button deck as the monitor assembly is raised.

22. The assembly process, as set forth in claim 13, wherein the gaming machine cabinet further comprises a pair of supports, the pair of supports configured to be fastened to, and across, the upper and lower towers to provide support and rigidity to the tower assembly when in the installed configuration.

23. A gaming machine cabinet for a gaming machine with a monitor assembly, comprising:
a base cabinet having an upper end, a bottom end, and a front side;
a tower assembly having a chassis configured to receive the monitor assembly, the tower assembly including a lower tower and an upper tower, the lower tower being coupled to the upper end of the base cabinet and extending upward therefrom, the upper tower being rotatably coupled to the lower tower and being movable between a shipping configuration and an installed configuration, the lower tower having a lower tower upper end and a lower tower bottom end, the lower tower bottom end being coupled to the upper end of the base cabinet, the lower tower extending from the upper end of the base, the upper tower having upper tower upper end and an upper tower bottom end, the upper tower bottom end being rotatably coupled to the lower tower upper end at the pivot point, wherein the upper tower extends upward from the lower tower when in the installed configuration;
a removable frame having a first end and a second end, the removable frame having a storage state and an assembly s, wherein at least a portion of the removable frame is stored within the base cabinet or tower assembly when the removable frame is in the storage state, when in the assembly state, the first end of the removable frame being coupled to the tower assembly, the removable frame extending downward and away from the tower assembly and base cabinet toward the second end of the removable frame, and the removable frame forming a ramp;
a button deck coupled to the front side of base cabinet and extending therefrom, and,
a lift mechanism coupled to the tower assembly and having an attachment device configured to be temporarily coupled to the monitor assembly and to controllably lift the monitor assembly along the ramp formed by the removable frame until the monitor assembly is in position relative to the tower assembly, wherein the ramp defined by the removable frame, is located adjacent the button deck, such that the monitor assembly avoids the button deck as the monitor assembly is lifted into position by the lift mechanism, the lift mechanism including a winch having a winch cable, the attachment device including a pair of carabiner clips coupled to one end of the winch cable.

24. A gaming machine cabinet, comprising:
a base cabinet;
a button panel attached to a face of the base cabinet;
a tower assembly including:
a lower tower connected to the base cabinet and extending upward; and,
an upper tower rotatably connected to the lower tower, the upper tower having a shipping configuration and an installed configuration;
a chassis rotatably connected to the upper tower;
a removable frame comprised of a plurality of rail components, wherein:
when the removable frame is in a storage state the plurality of rail components are positioned between the chassis and a back wall of the lower tower; and
when the removable frame is in an assembly state, the plurality of rail components forming a ramp extending from the chassis to the floor and having a central portion extending about the button panel, the central portion configured to avoid substantive contact with the button panel; and,
a lift mechanism coupled to the tower assembly, the lift mechanism including an attachment device configured to be temporarily coupled to a monitor assembly, wherein the lift mechanism is configured to controllably move the monitor assembly along the removable frame to the chassis.
